(19) United States
(12) Patent Application Publication
(10) Pub. No.: US 2016/0102950 A1
(43) Pub. Date: Apr. 14, 2016

(54) FLEXIBLE BALLISTIC RESISTANT PANEL

(71) Applicant: Angel Armor, LLC, Fort Collins, CO (US)

(72) Inventor: Eric B. Strauss, Fort Collins, CO (US)

(21) Appl. No.: 14/322,931

(22) Filed: Jul. 3, 2014

Related U.S. Application Data
(60) Provisional application No. 61/842,937, filed on Jul. 3, 2013.
(60) Provisional application No. 61/903,337, filed on Nov. 12, 2013.

(51) Int. Cl. F41H 5/04; B32B 5/26; B32B 5/02; B32B 7/02

(52) U.S. Cl. CPC F41H 5/04; F41H 5/0485; F41H 5/0442; B32B 7/02; B32B 5/26; B32B 5/024; B32B 5/022; B32B 2255/02; B32B 2255/10; B32B 2262/02; B32B 2262/103; B32B 2262/101; B32B 2571/02

(57) ABSTRACT

A flexible ballistic resistant panel can include a first plurality of ballistic sheets comprising high performance fibers, a second plurality of ballistic sheets comprising high performance fibers, and a third plurality of ballistic sheets comprising high performance fibers. The second plurality of ballistic sheets can be adjacent to the first plurality of ballistic sheets, and the third plurality of ballistic sheets can be adjacent to the second plurality of ballistic sheets. Each ballistic sheet within the first plurality of ballistic sheets can be at least partially bonded to at least one adjacent ballistic sheet in the first plurality of ballistic sheets. Similarly, each ballistic sheet within the third plurality of ballistic sheets can be at least partially bonded to at least one adjacent ballistic sheet in the third plurality of ballistic sheets. The first, second, and third pluralities of ballistic sheets can be encased by a waterproof cover.

### CROSS-REFERENCE TO RELATED APPLICATIONS

This application claims priority to U.S. Provisional Application No. 61/842,937, filed Jul. 3, 2013, and U.S. Provisional Application No. 61/903,337, filed Nov. 12, 2013, both of which are incorporated by reference herein as if fully set forth in this description.

### BACKGROUND

Ballistic resistant panels can safeguard people and property from ballistic threats, such as projectiles. More specifically, ballistic resistant panels can be incorporated into bullet-proof vests to protect people from projectiles, such as bullets or shrapnel, and can be incorporated into vehicle doors and floors to prevent occupants and equipment from projectiles. Ballistic resistant panels are commonly made of woven fabrics consisting of high performance fibers, such as aramid fibers. When struck by a projectile, fibers in the woven fabric dissipate impact energy transferred from the projectile by stretching and breaking, thereby providing a certain level of ballistic protection.

Existing ballistic resistant panels are often made of a stack of woven ballistic sheets stitched together by a sewing process that requires an industrial sewing machine. The level of ballistic protection provided by the panel is largely dictated by the type of fibers in the woven ballistic sheets, the number of woven ballistic sheets in the stack, and the stitching pattern used to bind the woven ballistic sheets together into a panel. A wide variety of stitching patterns are used in existing panels, including quilt stitches, radial stitches, row stitches, and box stitches.

When a projectile strikes a panel made of a stack of woven ballistic sheets bound by stitching, each woven ballistic sheet dissipates a certain portion of the energy of the projectile as the projectile passes through each sheet. Within each woven ballistic sheet, individual fibers stretch and break apart as the projectile penetrates the sheet. The impact energy absorbed by a struck fiber will be transferred and dissipated to nearby fibers at crossover points where the fibers are interwoven. Also, individual stitches will stretch and break as the projectile enters the panel, thereby dissipating impact energy from the projectile and acting as a sacrificial element of the panel.

Due to the sacrificial nature of the fibers and stitches, the panel will be severely damaged after being struck by a projectile. Visual inspection of the panel will typically reveal significant damage to the woven ballistic sheets and to stitches both at the impact location and the surrounding area. If a second projectile strikes the panel at or near the first impact location, the panel will not effectively stop the second projectile, and the second projectile will pass through the panel and into a person or property behind the panel. Therefore, existing panels do not provide reliable protection against multiple projectiles striking the panel in close proximity, which is a common threat posed by many automatic and semi-automatic weapons. For at least this reason, existing ballistic resistant panels are not well-suited for combat environments or other applications where multi-round capability is required.

### BRIEF DESCRIPTIONS OF DRAWINGS

FIG. 1 shows a process of fabricating a roll of ballistic sheet material using a plurality of fibers drawn from creels.

FIG. 2 shows a process of forming a 0/90 x-ply ballistic sheet from two rolls of unidirectional ballistic sheet material.

FIG. 3 shows a process of forming a 0/90 x-ply ballistic sheet from two unidirectional ballistic sheets.

FIG. 4 shows a magnified view of a portion of a 0/90 x-ply ballistic sheet containing two layers of resin film and two unidirectional ballistic sheets.

FIG. 5 shows a carrier vest with a pouch containing a flexible ballistic-resistant panel (e.g. soft armor) positioned behind a rigid or semi-rigid ballistic resistant member (e.g. hard armor).

FIG. 6 shows a prior art bullet-proof vest with an edge seam undone to expose a stack of ballistic sheets fanned out with no partial or full bonding between adjacent sheets.

FIG. 7 shows a process of arranging a stack of ballistic sheets according to a two-dimensional pattern inside a waterproof cover prior to a vacuum bagging process.

FIG. 8 shows two stacks of ballistic sheets, each wrapped in a waterproof cover and ready for insertion into a vacuum bag sized to accommodate several flexible ballistic resistant panels during a vacuum bagging process.

FIG. 9 shows a vacuum bagging process employing a vacuum bag sized to accommodate one flexible ballistic resistant panel.

FIG. 10 is a cross-sectional side view of a flexible ballistic resistant panel containing a plurality of ballistic sheets, each of the plurality of ballistic sheets being formed of an arrangement of fibers that defines a two-dimensional pattern, the first plurality of ballistic sheets being stacked according to the two-dimensional pattern.

FIG. 11 is a cross-sectional side view of a flexible ballistic resistant panel containing a stack of ballistic sheets and a waterproof cover where the stack of ballistic sheets includes a first plurality of ballistic sheets, a second plurality of ballistic sheets adjacent to the first plurality of ballistic sheets, and a third plurality of ballistic sheets adjacent to the second plurality of ballistic sheets.

FIG. 12 is a cross-sectional side view of a flexible ballistic resistant panel including a stack of ballistic sheets and a waterproof cover where the stack of ballistic sheets includes a first plurality of ballistic sheets, a second plurality of ballistic sheets adjacent to the first plurality of ballistic sheets, and a third plurality of ballistic sheets adjacent to the second plurality of ballistic sheets.

FIG. 13 is a cross-sectional side view of a flexible ballistic resistant panel including a stack of ballistic sheets and a waterproof cover where the stack of ballistic sheets includes a first plurality of ballistic sheets, a second plurality of ballistic sheets adjacent to the first plurality of ballistic sheets, and a third plurality of ballistic sheets adjacent to the second plurality of ballistic sheets.

FIG. 14 is a cross-sectional side view of a stack of two flexible ballistic resistant panels, where each of the two panels is encased by a cover and the entire apparatus is encased by an outer cover.

FIG. 15 shows a cross-section side view of two stacks of ballistic sheets combined within a single waterproof cover to form a combined stack of ballistic sheets including a first plurality of ballistic sheets, a second plurality of ballistic sheets, a third plurality of ballistic sheets, a fourth plurality of ballistic sheets, and a fifth plurality of ballistic sheets.

FIG. 16 is a side cross-sectional view of a stack of three flexible ballistic resistant panels within a waterproof cover, where each panel is also encased in its own cover.

### DETAILED DESCRIPTION

Ballistic resistant panels are described herein that have significantly better multi-shot capability than existing panels. In addition, the ballistic resistant panels described herein can be lighter, thinner, more flexible, easier to conceal, and less expensive to manufacture than existing panels. The panels described herein can be made in a reversible configuration where either side of the panel can serve as a strike face, thereby avoiding risks associated with user error. The panels described herein can prevent ricochet of projectiles (which is an inherent drawback of metal armor) by, for example, encapsulating the projective through controlled delamination and energy absorption. The panels described herein can experience significantly less back face deformation than existing panels when exposed to an identical ballistic threat. Methods of manufacturing the ballistic resistant panels, as described herein, can involve one or more steps, including cutting ballistic sheets, stacking ballistic sheets, sealing ballistic sheets within a waterproof cover, vacuum bagging a stack of ballistic sheets, heating a stack of ballistic sheets, applying pressure to a stack of ballistic sheets, cooling a stack of ballistic sheets, trimming a waterproof cover, and breaking-in the ballistic panel.

The ballistic resistant panels described herein are capable of absorbing and dissipating energy from high-velocity impacts through one or more of the following energy-absorbing mechanisms: spall formation, tensile fiber failure, fiber de-bonding, fiber pullout, and interlayer delamination. The term “panel,” as used herein, can describe any 3-dimensionally shaped ballistic resistant apparatus, including a flat or contoured shape having any suitable perimeter shape, including regular or irregular perimeter shapes. In some applications, the panel may include one or more openings. For example, if the panel is used within a vehicle door, the panel may include an opening to accommodate a component located within the door, such as a wiring harness.

### Wide-Ranging Applications

The flexible ballistic resistant panels 100 described herein are lightweight and flexible and can be used in a wide range of applications that requires dissipation of impact energy. The ballistic resistant panels 100 described herein have a wide variety of applications, including, but not limited to, body armor (e.g. bullet-proof vests), vehicle armor, wall coverings, backpacks, backpack inserts, protective cases for electronic equipment, athletic equipment (e.g. helmet, chest protector), barricades, vehicle tires, pipeline coverings, doors, wall inserts, military helmets, public speaking podiums, theater seats, removable theater seat cushions, airline seats, removable airline seat cushions, cockpit doors for aircrafts, military tents, vehicle window coverings, garments (e.g. jackets), personal accessories (e.g. purses), mattresses, or inflatable vessels (e.g. inflatable boats).

The flexible ballistic resistant panels 100 described herein can serve as spall liners in tanks and other armored vehicles to protect against, for example, the effects of high explosive squash head (HESH) anti-tank shells. Spall liners can serve as a secondary armor for occupants and equipment within an armored vehicle having a primary armor made of steel, ceramic, aluminum, or titanium. In the event of an impact or explosion proximate an outer surface of the armored vehicle, the spall liner can prevent or reduce fragmentation into the vehicle cabin, which is desirable, since fragmentation can result in fragments flying into the vehicle cabin, which may cause more injury to vehicle occupants than the original explosion. When used as a spall liner, the ballistic resistant panels 100 can be positioned between exterior steel armor plating of the military vehicle and the cabin of the vehicle. To provide adequate protection against spall, it may be necessary to provide a stack of ballistic resistant panels, where the stack includes one or more ballistic panels 100 in combination.

The flexible ballistic resistant panels 100 described herein can be incorporated into vehicle doors, floors, firewalls, roofs, and seats to protect the vehicle, occupants, equipment, and ammunitions in the vehicle from projectiles. Due to their light weight and low cost, the panels 100 described herein can be incorporated into consumer vehicles without significantly reducing fuel economy or increasing vehicle cost. In addition to protecting against ballistic threats, the panels 100 may improve certain aspects of crash performance of vehicles. Due to the flexibility and thinness of the panels 100, a panel can be installed into a vehicle door between a door window and window seal. This allows existing vehicles to be easily armored without needing to fully disassemble the door panels. The flexible panel can be easily inserted into a door cavity and can be contorted around door components. Due to the relatively soft nature of the panels described herein, the panels do not cause unwanted noise or vibration.

The flexible ballistic resistant panels 100 described herein can be used to protect commercial, governmental, or residential buildings (e.g. banks, homes, schools, office buildings, prisons, restaurants, laboratories, churches, and convenience stores) from ballistic threats. The panels 100 can be incorporated into walls, floors, or ceilings (e.g. in homes, banks, or law enforcement facilities). In one example, the panels 100 can be incorporated into a wall and concealed by or within drywall. In this way, the panel may not be visible and may not detract from the appearance of the wall. The panels 100 can be incorporated into manufactured (i.e. pre-made) walls that are delivered to a construction site, or the panels can be inserted into walls that are built on site. In another example, a ballistic resistant panel 100 can serve as a wall component and can include an exterior covering (e.g. drywall) that is adapted to be paintable to replicate the appearance of a traditional wall in a home or office building. In this example, the ballistic panel 100 may include a structural component that supports the panel in an upright position and allows the panel to be mounted in place.

The flexible ballistic resistant panels 100 described herein can be used to cover and protect pipelines, such as petroleum or gas pipelines, from ballistic threats. The panels 100 can be wrapped around an external surface of the pipeline and can prevent a vandal or terrorist (e.g. in a conflict zone) form piercing the pipeline by firing a bullet or other projectile at the pipeline. Some pipelines are positioned above ground and are exposed to weather. As described herein, the panel 100 can include an external cover made from a suitable waterproof material. The cover can prevent ballistic sheets within the panel from being damaged by rain or other forms of precipitation. The cover can be UV-resistant and can prevent sun damage and any performance degradation associated therewith. In one example, the panels can be installed after the pipeline is in place. The panels 100 can be attached to the pipeline using any suitable fasteners, including, for example, magnets, snaps, adhesives, or external straps. The panels 100 can be interlocked using, for example, snaps, zippers, tongue and groove connectors, or hook and look fasteners, to prevent unwanted shifting of the panels after installation due to wind, which could leave portions of the pipeline exposed and vulnerable to ballistic threats.

The flexible ballistic resistant panels 100 described herein can be incorporated into vehicle tires to protect them from ballistic threats. For example, a panel 100 can be incorporated into the sidewall of a military vehicle tire to prevent against punctures caused by projectiles. The panels 100 can replace heavy and costly steel armor. In one example, the panel 100 can be attached to a sidewall of the tire and can provide a protective covering that may be removable and replaceable if damaged. In another example, the panel 100 can be integrated into the tire (e.g. disposed within the rubber compound of the tire). In this configuration, the panel 100 can protect the sidewall or the treaded surface of the tire from ballistic threats, including projectiles (e.g. bullets) or shrapnel from blasts caused by landmines or grenades.

The flexible ballistic resistant panels 100 described herein can be incorporated into temporary or permanent barricades. Barricades are often used to divert traffic and pedestrians at large public gatherings or to prevent vehicles from accessing certain areas. To protect citizens from certain terrorist threats at public gatherings (e.g. shrapnel from an improvised explosive device), it can be desirable to incorporate ballistic panels 100, as described herein, into barricades. Due to their light weight and low cost, the panels 100 are well-suited for incorporation into a temporary barricade that is easily transported by one or more individuals and not significantly more expensive than a traditional temporary barricade.

### No Stitching Required

An advantage of the flexible ballistic resistant panels 100 described herein over existing panels is that no stitching is required to manufacture the panels. Instead of stitching, combinations of processes described herein (e.g. vacuum-bagging, applying heat, applying pressure) result in full or partial bonding between adjacent layers of ballistic sheets in the stack 1005. This full or partial bonding resists movement of the ballistic sheets relative to each other (similar to how a stitch would) and improves performance of the panel when struck by a projectile. Panels without stitching are far less labor intensive than panels with stitching and don't require access to industrial sewing machines. Consequently, panels without stitching can be manufactured at a lower cost.

### Ballistic Sheet Construction

A ballistic resistant panel can be made of one or more ballistic sheets. The term “sheet,” as used herein, can describe one or more layers of any suitable material, such as a polymer, metal, fiberglass, or composite material, or combination thereof. Examples of polymers include aramids, para-aramids, meta-aramids, polyolefins, and thermoplastic polyethylenes. Examples of aramids, para-aramids, meta-aramids include NOMEX, KERMEL, KEVLAR, TWARON, NEW STAR, TECHNORA, HERACRON, and TEIJINCONEX. An example of a polyolefin is INNEGRA. Examples of thermoplastic polyethylenes include TENSYLON from E. I. du Pont de Nemours and Company, DYNEEMA from Dutch-based DSM, and SPECTRA from Honeywell International, Inc., which are all examples of ultra-high-molecular-weight polyethylenes (UHMWPE). Examples of types of glass fibers include A-glass, C-glass, D-glass, E-glass, E-CR-glass, R-glass, S-glass, and T-glass. Other suitable fibers include M5 (polyhydroquinone-diimidazopyridine), which is both high-strength and fire-resistant.

A ballistic sheet 10 can be constructed using any suitable manufacturing process, such as extruding, die cutting, forming, pressing, weaving, rolling, etc. The sheet can include a woven or non-woven construction of a plurality of fibers bonded by a resin, such as a thermoplastic polymer, thermoset polymer, elastic resin, or other suitable resin. In one example, the ballistic sheet 10 can include a plurality of aramid bundles of fibers 11 bonded by a resin containing 16, for example, polypropylene, polyethylene, polyester, or phenol formaldehyde. The plurality of bundles of fibers 11 in the sheet 10 can be oriented in the same direction, thereby creating a unidirectional fiber arrangement, known as a uni-ply ballistic sheet 10.

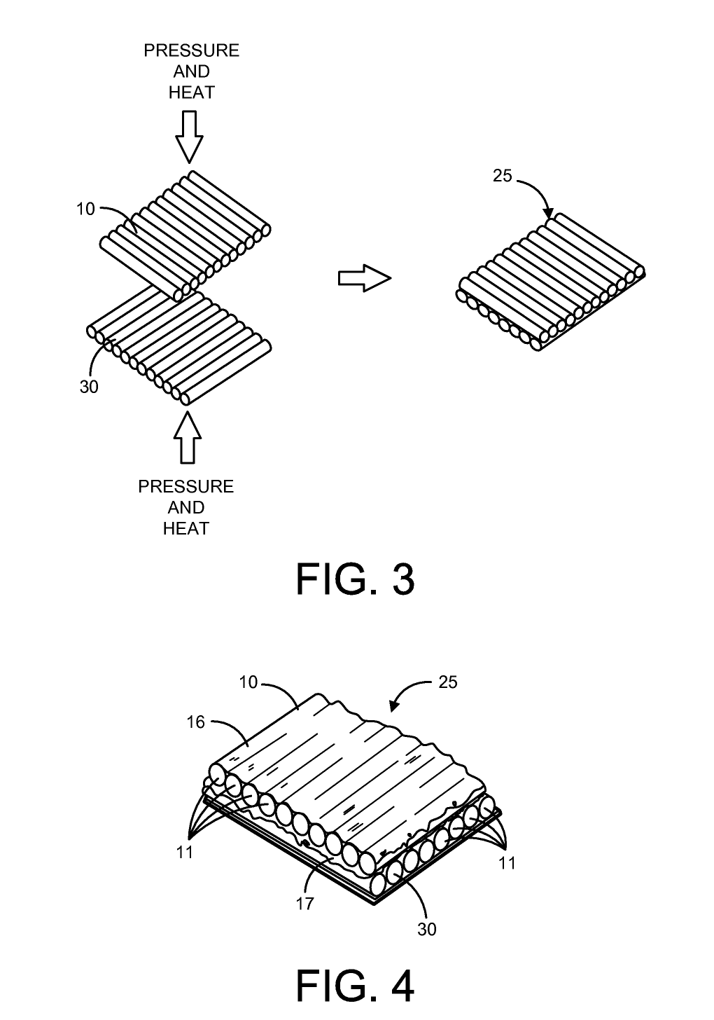

In some examples, the ballistic sheet 10 can include fibers 11 that are pre-impregnated with a resin, such as thermoplastic polymer, thermoset polymer, epoxy, or other suitable resin. The fibers 11 can be arranged in a woven pattern or arranged unidirectionally, as shown in FIG. 3. The resin can be partially cured to allow for easy handling and storage of the ballistic sheet prior to formation of the panel. To prevent complete curing (e.g. polymerization) of the resin before the sheet 10 is incorporated into a panel, the ballistic sheet may require cold storage.

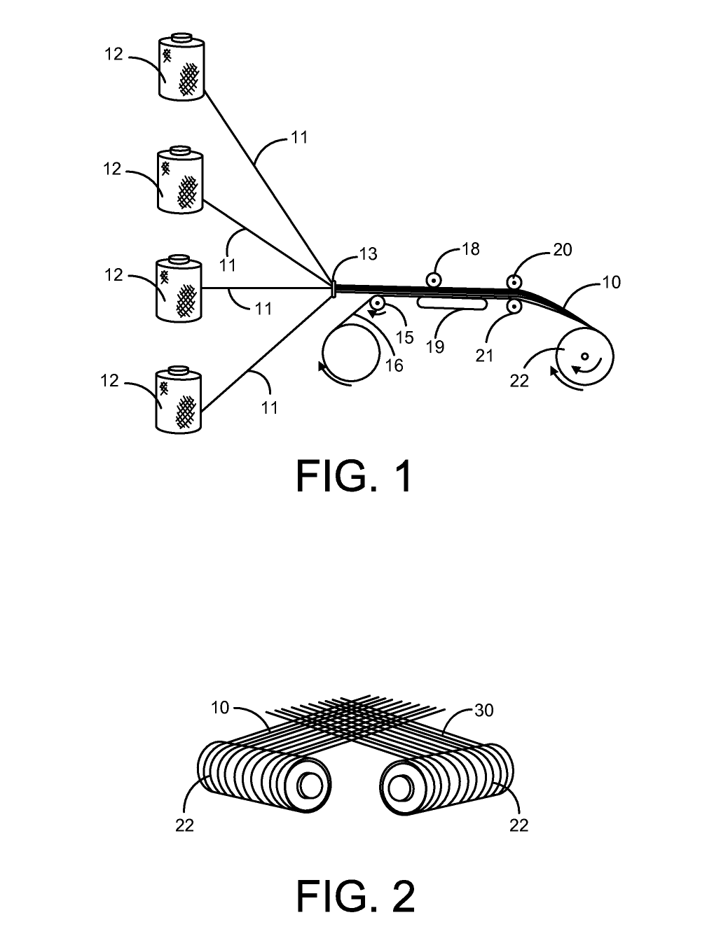

Certain ballistic sheets are described in U.S. Pat. No. 5,437,905, which is hereby incorporated by reference in its entirety. FIG. 1 shows an example method for forming an array from a plurality of bundles of fibers 11. The bundles of fibers 11 can be supplied from a plurality of yarn creels 12. The bundles of fibers 11 can pass through a comb guide 13 where the bundles of fibers are arranged in a parallel orientation and formed into an array and passed over a resin application roller 15 where a resin film 16, such as a thin polyethylene or polypropylene film or other suitable film, is applied to one side of the array. The bundles of fibers 11 may be twisted or stretched prior to passing over the resin application roller 15 to increase their tenacity. A pre-lamination roller 18 can then press the array of bundles of fibers 11 against the resin film 16, which is then pressed against a heated plate 19, which causes the resin film to adhere to the array. After heating, the bundles of fibers 11 and the resin film 16 can be passed through a pair of heated pinch rolls 20, 21 to form a ballistic sheet. The ballistic sheet 10 can then be wound onto a roll 22.

As shown in FIGS. 2-4, two ballistic sheets, known as uni-ply, having unidirectional arrangements of fibers 10 can be bonded together to produce a configuration known as x-ply 25. X-ply 25 can include a first ballistic sheet 10 and a second ballistic sheet 30, each having a two-dimensional arrangement of unidirectionally-oriented fibers 11. The second ballistic sheet 30 can be arranged at a 90-degree angle with respect to the first ballistic sheet 10, which is set to a reference angle of 0-degrees, as shown in FIG. 3. This configuration is known as 0/90 x-ply, where “0” and “90” denote the relative orientations (in degrees) of the bundles of fibers 11 within the first and second ballistic sheets (10, 30), respectively. The first ballistic sheet 10 can be laminated to the second ballistic sheet 30 in the absence of adhesives or bonding agents. Instead, a first thermoplastic film 16 and second thermoplastic resin film 17 can be bonded to the outer surfaces of the first and second ballistic sheets (10, 30) without penetration of the resin films into the bundles of fibers 11 or through the laminated sheets from one side to the other. Through a process involving heat and pressure, as shown in FIG. 3, the resin films (16, 17) melt and subsequently solidify to effectively laminate the uni-ply ballistic sheets (10, 30) to each other, as shown in FIG. 4, thereby producing a 0/90 x-ply configuration.

### Ballistic Sheet Resin

Ballistic sheets (e.g. 25) can be coated or impregnated with one or more resins (e.g. 16). Certain resins, such as resins made of thermoplastic polymers, may include long chain molecules. The chains of molecules may be held close to each other by weaker secondary forces. Upon heating, the secondary forces may be reduced, thereby permitting sliding of the chains of molecules and resulting in visco-plastic flow and ease in molding. Heating of the ballistic sheets (e.g. 25) may cause softening of the resin, and the resin may become tacky as it softens. Softening may occur at the softening point, which is the temperature at which the resin softens beyond some arbitrary softness and can be determined, for example, by the Vicat method (ASTM-D1525). Applying pressure to the stack of ballistic sheets 1005 when the resin is softened and tacky may result in a softened resin layer on a first ballistic sheet contacting and adhering to a second ballistic sheet that is adjacent to the first ballistic sheet, and when the panel 100 is subsequently cooled and the temperature of the resin is reduced, the first and second ballistic sheets may be partially or fully bonded to each other. In one example, ballistic sheets in a panel may be coated or impregnated with a polypropylene resin, and the polypropylene resin may have a melting point of about 255-295 or 295-330 degrees F. In another example, ballistic sheets in a panel may be coated or impregnated with a polyethylene resin, and the polyethylene resin may have a melting point of about 215-240 degrees F. During a manufacturing process to make a ballistic resistant panel 100, the stack of ballistic sheets 1005 may be heated to a temperature near the melting point of the resin to cause softening of the resin, and pressure may be applied to the stack of ballistic sheets to press adjacent ballistic sheets closer together. When the panel 100 is cooled, and the temperature of the resin is reduced, adjacent ballistic sheets (e.g. 25) may be left partially or fully bonded to each other.

When forming a ballistic panel 100 from one or more ballistic sheets (e.g. 25) containing one or more resins, a suitable processing temperature for the panel can be dictated, at least partly, by the resin type and resin content (i.e. percent weight) of the ballistic sheets. Selecting a resin with a lower melting point may reduce a target processing temperature for the panel 100, and selecting a resin with a higher melting point may increase the target processing temperature for the panel. The amount of partial or full bonding that occurs between adjacent ballistic sheets in the stack can be controlled, at least in part, by resin selection, resin content, process temperature, and process pressure.

### Commercially-Available Ballistic Sheets

Ballistic sheets constructed from high performance fibers, such as fibers made of aramids, para-aramids, meta-aramids, polyolefins, or ultra-high-molecular-weight polyethylenes, are commercially available from a variety of manufacturers. Several specific examples of commercially-available ballistic sheets made of high performance fibers are provided below. Ballistic sheets are commercially-available in many configurations, including uni-ply, 0/90 x-ply, and 0/90/0/90 double x-ply configurations. Ballistic sheeting material can be ordered in a wide variety of forms, including tapes, laminates, rolls, sheets, structural sandwich panels, and preformed inserts, which can all be cut to size during a manufacturing process.

TechFiber, LLC, located in Arizona, manufactures a variety of ballistic sheets made of aramid fibers that are sold under the trademark K-FLEX. One version of K-FLEX is made with KEVLAR fibers having a denier of about 1000 and a pick count of about 18 picks per inch. K-FLEX can have a resin content of about 15-20%. Different versions of K-FLEX may contain different resins. For instance, a first version of K-FLEX can include a resin (e.g. a polyethylene resin) with a melting temperature of about 215-240 degrees F., a second version of K-FLEX can include a resin with a melting temperature of about 240-265 degrees F., a third version of K-FLEX can include a resin with a melting temperature of about 265-295 degrees F., and a fourth version of K-FLEX can include a resin with a melting temperature of about 295-340. K-FLEX is available in uni-ply, 0/90 x-ply, and 0/90/0/90 double x-ply configurations.

TechFiber, LLC also manufactures a variety of unidirectional ballistic sheets made of aramid fibers that are sold under the trademark T-FLEX. Certain versions of T-FLEX can have a resin content of about 15-20% and can include aramid fibers such as TWARON fibers (e.g. model number T765). Different versions of T-FLEX may contain different resins. For instance, a first version of T-FLEX can include a resin (e.g. a polyethylene resin) with a melting temperature of about 215-240 degrees F., a second version of T-FLEX can include a resin with a melting temperature of about 240-265 degrees F., a third version of T-FLEX can include a resin with a melting temperature of about 265-295 degrees F., and a fourth version of T-FLEX can include a resin with a melting temperature of about 295-340 degrees F. T-FLEX is available in uni-ply, 0/90 x-ply, and 0/90/0/90 double x-ply configurations.

Polystrand, Inc., located in Colorado, manufactures a variety of unidirectional ballistic sheets made of aramid fibers that are sold under the trademark THERMOBALLISTIC. One version of THERMOBALLISTIC ballistic sheets are sold as product number TBA-8510 and include aramid fibers with a pick count of about 12.5 picks per inch. Other versions of THERMOBALLISTIC ballistic sheets are sold as product numbers TBA-8510X and TBA-9010X and include aramid fibers (e.g. KEVLAR fibers) and have a 0/90 x-ply configuration. The resin content of the THEMROBALLISTIC ballistic sheets can be about 10-20% or 15-20%. Different versions of THERMOBALLISTIC ballistic sheets may contain different resins. For instance, a first version of THERMOBALLISTIC ballistic sheets can include a resin with a melting temperature of about 225-255 degrees F., a second version of THERMOBALLISTIC ballistic sheets can include a resin (e.g. a polypropylene resin) with a melting temperature of about 255-295 degrees F., a third version of THERMOBALLISTIC ballistic sheets can include a resin (e.g. a polypropylene resin) with a melting temperature of about 295-330 degrees F., a fourth version of THERMOBALLISTIC ballistic sheets can include a resin with a melting temperature of about 330-355 degrees F., and a fifth version of THERMOBALLISTIC ballistic sheets can include a resin with a melting temperature of about 355-375 degrees F. One version of THERMOBALLISTIC ballistic sheets can include a polypropylene resin. THERMOBALLISTIC ballistic sheets are available in uni-ply, 0/90 x-ply, and 0/90/0/90 double x-ply configurations.

E. I. du Pont de Nemours and Company (DuPont), located in Delaware, manufactures a ballistic sheet material made of ultra-high-molecular-weight polyethylene fabric that is sold under the trademark TENSYLON. A Material Data Safety Sheet was prepared on Feb. 2, 2010 for a material sold under the tradename TENSYLON HTBD-09-A (Gen 2) by BAE Systems TENSYLON High Performance Materials. The Material Safety Data Sheet is identified as TENSYLON MSDS Number 1005, is publicly available, and is hereby incorporated by reference in its entirety. The ballistic sheets are marketed as being lightweight and cost-effective and boast low back face deformation, excellent flexural modulus, and superior multi-threat capability over other commercially available ballistic sheets. The ballistic sheet material can be purchased on a roll and can be cut into ballistic sheets having a size and shape dictated by an intended application.

Honeywell International, Inc., headquartered in New Jersey, manufactures a variety of ballistic sheets made of aramid fibers that are sold under the trademark GOLD SHIELD. One version of GOLD SHIELD ballistic sheets are sold under product number GN-2117 and are available in 0/90 x-ply configurations and have an areal density of about 3.24 ounces per square yard.

Barrday, Inc., headquartered in Cambridge, Ontario, manufactures a variety of ballistic sheets made of para-aramid fibers that are sold under the trademark BARRFLEX. One version of BARRFLEX ballistic sheets is sold as product number U480 and is available in 0/90 x-ply configurations. Each layer of the ballistic sheet is individually constructed with a thermoplastic film laminated to a top and bottom surface.

### Protective Cover

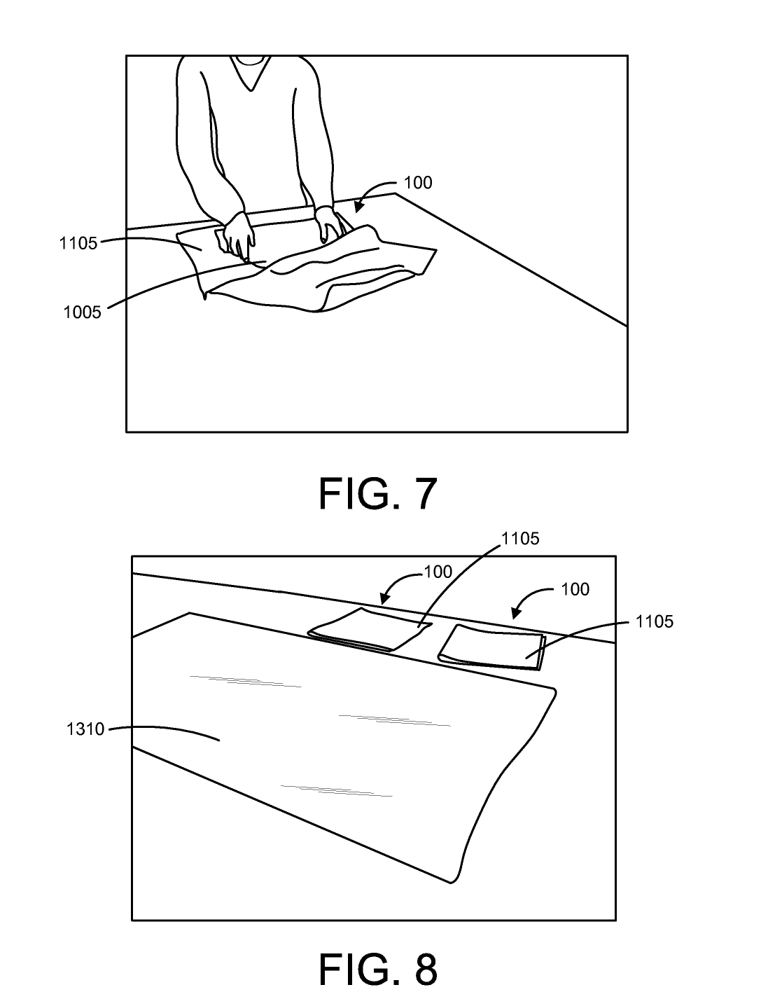

The stack of ballistic sheets 1005 can be encased in a protective cover 1105. In one example, protective cover 1105 can be a waterproof cover, thereby producing a waterproof ballistic resistant panel. The waterproof cover 1105 can be adapted to prevent the ingress of liquid through the cover toward the ballistic sheets encased by the cover. FIG. 7 shows one step of a manufacturing process for making a flexible ballistic resistant panel. In FIG. 7, a stack of ballistic sheets 1005 is being positioned within a waterproof cover 1105 prior to a vacuum bagging process. Preventing water ingress can be desirable, since moisture can negatively affect the performance of the ballistic sheets. In particular, moisture can negatively affect tensile strength of certain fibers 11 (e.g. aramid fibers) within the ballistic sheets (e.g. 25), thereby resulting in the sheets being less effective at dissipating impact energy from a projectile.

The protective cover 1105 can be made from any suitable material such as, for example, rubber, NYLON, RAYON, ripstop NYLON, CORDURA, polyvinyl chloride (PVC), polyurethane, silicone elastomer, fluoropolymer, or any combination thereof. The cover 1105 can be a coating that contains polyurethane, polyuria, or epoxy, such as a coating sold by Rhino Linings Corporation, located in San Diego, Calif. In another example, the waterproof cover 1105 can be made from any suitable waterproof or non-waterproof material and coated with a waterproof material such as, for example, rubber, PVC, polyurethane, polytetrafluoroethylene, silicone elastomer, fluoropolymer, wax, or any combination thereof. In one example, the cover 1105 can be made from NYLON coated with PVC. In another example, the cover can be made from NYLON coated with thermoplastic polyurethane. The cover 1105 can be made of any suitable material, such as about 50, 70, 200, 400, 600, 840, 1050, or 1680-denier NYLON coated with thermoplastic polyurethane. In yet another example, the cover can be made from 1000-denier CORDURA coated with thermoplastic polyurethane.

In addition to being made of a waterproof material that protects the ballistic sheets (e.g. 25) from water ingress, the protective cover 1105 can also be made of a chemically-resistant material to protect the ballistic sheets if the panel were ever exposed to acids or bases. Certain acids and bases can cause the tenacity of certain fibers, such as aramid fibers, to degrade over time, where “tenacity” is a measure of strength of a fiber or yarn. It is therefore desirable, in certain applications where exposure to chemicals is possible, for the cover 1105 to be resistant to acids and bases to prevent the cover from deteriorating if ever exposed to acids or bases. Deterioration of the cover would be undesirable, since it would permit the acids and bases to breach the cover material and reach the stack of ballistic sheets 1005 inside the cover. To this end, the cover 1105 can be made of a chemically-resistant material or can include a chemically-resistant coating on an outer surface of the cover. For instance, the cover 1105 can include a thermoplastic polymer coating on an outer surface of the cover. Examples of chemically-resistant thermoplastic polymers that can be used to coat the cover include polypropylene, low-density polyethylene, medium-density polyethylene, high-density polyethylene, ultra-high-molecular-weight polyethylene, and polytetrafluoroethylene (e.g. TEFLON).

The protective cover 1105 can made of a flame-resistant or flame-retardant material. In one example, the cover 1105 can include a flame-resistant or flame-retardant material mixed with a base material. In another example, the cover 1105 can include a base material coated with a flame-resistant or flame-retardant material. In yet another example, the cover can include a base material with a flame-resistant or flame-retardant material chemically bonded to the base material. The flame-resistant or flame-retardant material can be a phenolic resin, a phenolic/epoxy composite, NOMEX, an organohalogen compound (e.g. chlorendic acid derivative, chlorinated paraffin, decabromodiphenyl ether, decabromodiphenyl ethane, brominated polystyrene, brominated carbonate oligomer, brominated epoxy oligomer, tetrabromophthalic anyhydride, tetrabromobisphenol A, or hexabromocyclododecane), an organophosphorus compound (e.g. triphenyl phosphate, resorcinol bis(diphenylphosphate), bisphenol A diphenyl phosphate, tricresyl phosphate, dimethyl methylphosphonate, aluminum diethyl phosphinate, brominated tris, chlorinated tris, or tetrekis(2-chlorethyl)dichloroisopentyldiphosphate, antimony trioxide, or sodium antimonite), or a mineral (e.g. aluminium hydroxide, magnesium hydroxide, huntite, hydromagnesite, red phosphorus, or zinc borate).

The protective cover 1105, along with the stack of ballistic sheets 1005, can be heated and subjected to a vacuum bagging process, thereby partially or fully bonding an inner surface of the cover to the stack of ballistic sheets 1005 encased by the cover. Full or partial bonding can prevent the stack of ballistic sheets 1005 from shifting within the cover 1105 during use, which can be important to ensure that ballistic performance of the panel 100 is maintained. The cover 1105 can include a temperature sensitive adhesive or a layer of resin on an inner surface. The cover 1105 can be heated to promote full or partial bonding of the inner surface of the cover to the stack of ballistic sheets 1005 due to the adhesive or resin. In one example, the cover can be made of a material that is coated with polyurethane, polypropylene, vinyl, polyethylene, or a combination thereof, on the inner surface the cover. Heating the cover 1105 to a temperature above the melting point of the adhesive or resin and then cooling the cover below the melting point of the adhesive or resin can result in bonding of the inner surface of the cover to the outer surface of the stack of ballistic sheets 1005.

In some examples, the protective cover 1105 can be made of ripstop NYLON coated with polyurethane. The cover 1105 can be made of ripstop NYLON with a polyurethane coating that is about 0.1-1.5, 0.1-0.75, 0.1-0.5, or 0.25 mil thick. The cover 1105 can be made of 70-denier ripstop NYLON with a polyurethane coating that is about 0.1-1.5, 0.1-0.75, 0.1-0.5, or 0.25 mil thick. The polyurethane coating can be provided on an inner surface of the cover 1105. A durable water repellant finish can be provided on an outer surface of the cover 1105. Suitable polyurethane coated ripstop NYLON materials are commercially available under the trademark X-PAC from Rockywoods Fabrics, LLC located in Loveland, Colo.

### Vacuum Bagging

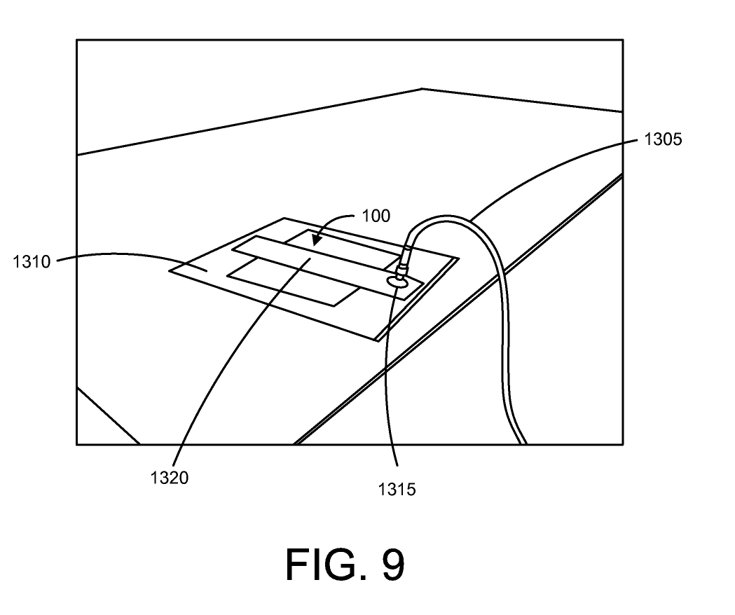

The stack of ballistic sheets 1005 can be vacuum bagged to remove air that is present between adjacent sheets (e.g. 25), thereby compressing the stack and reducing its thickness. During the vacuum bagging process, a stack of ballistic sheets 1005 are inserted into a vacuum bag, which is then sealed, as shown in FIG. 9. A vacuum hose 1305 extending from a vacuum pump is then connected to a vacuum port 1315 on the vacuum bag 1310, and the vacuum pump is activated to effectively evacuate air from the vacuum bag through the vacuum hose. A breather layer 1320 can be positioned between the panel 100 and the vacuum bag 1310 to ensure uniform evacuation of the vacuum bag. As air is evacuated from the vacuum bag 1310, the air pressure inside the bag decreases. Meanwhile, the ambient air pressure acting on the outside of the vacuum bag 1310 remains at atmospheric pressure (e.g. ˜14.7 psi). The pressure differential between the air pressure inside and outside the bag is sufficient to produce a suitable compressive force against the stack of ballistic sheets 1005 within the panel 100. The compressive force is applied uniformly over the panel 100, thereby resulting in a panel with uniform or nearly uniform thickness.

In one example, the vacuum bag 1310 can be sized to accommodate one ballistic panel 100, as shown in FIG. 9. In another example, the vacuum bag 1310 can be sized to accommodate a plurality of ballistic panels 100, as shown in FIG. 8. For instance, the vacuum bag can be sized to accommodate two or more, 2-20, 4-12, or 6-10 ballistic panels. Vacuum bagging batches of ballistic panels 100 can be more efficient than vacuum bagging individual panels, as shown in FIG. 9. Vacuum bagging batches of panels 100 also allows for quality testing of at least one panel per batch. Quality control testing of a panel 100 may involve destructive testing, such as firing projectiles at the panel to determine a V50 rating or a ballistic protection level. Therefore, it is desirable to make two or more panels in an identical vacuum bagging process, where it can be assumed that the panels that are not destructively tested will perform similarly to the panel that has been destructively tested.

The vacuum bag used in the vacuum bagging process can be reusable, which can reduce consumables and decrease labor costs. The reusable vacuum bag can be made from any suitable material, such as LEXAN, silicone rubber, TEFLON, fiberglass reinforced polyurethane, fiberglass reinforced polyester, or KEVLAR reinforced rubber.

### Heating Process

During formation of the ballistic resistant panel 100, the stack of ballistic sheets 1005 can be heated in a heating process. Heating can promote bonding (e.g. partial or full bonding) between adjacent ballistic sheets. When adjacent ballistic sheets are fully (i.e. completely) bonded, it may be difficult or nearly impossible to separate the sheets by hand, since former boundaries between adjacent sheets may no longer exist due to various degrees of melting. When adjacent sheets are partially bonded, it may still be possible to separate adjacent sheets by hand, depending on the extent of the partial bonding. Full or partial bonding is desirable since it can enhance the panel's ability to dissipate impact energy of a projectile that strikes the panel as the ballistic sheets within the panel experience delamination. During delamination, adjacent ballistic sheets that were partially or fully bonded prior to impact are separated (i.e. delaminated) in response to the projectile entering the panel, and the energy required to separate those ballistic sheets is dissipated from the projectile, thereby reducing the speed of the projectile and eventually stopping and capturing the projectile. A panel 100 containing ballistic sheets that are partially or fully bonded can more effectively dissipate impact energy from a projectile than a panel that has no bonding and is simply a stack of ballistic sheets sewn together, such as the ballistic sheets shown in the prior art bullet-proof vest in FIG. 6. The ballistic sheets in FIG. 6 have no partial or full bonding between adjacent layers, which is evident from the way the ballistic sheets can easily be fanned out after an edge seam is undone. For this reason, the bullet-proof vest in FIG. 6 is unable to match the ballistic performance of the panels 100 described herein.

In one example, heating of the stack of ballistic sheets 1005 can occur after the stack has been vacuum bagged and while the stack is still sealed within the vacuum bag 1310. In another example, the stack of ballistic sheets 1005 can be heated after vacuum bagging and after the stack has been removed from the vacuum bag 1310. In yet another example, heating can occur before the stack of ballistic sheets 1005 has been subjected to a vacuum bagging process.

Heating can occur using any suitable heating equipment such as, for example, a conventional oven, infrared oven, hydroclave, or autoclave. To ensure accurate temperature control throughout the heating process, the heating equipment can include a closed-loop controller, such as a proportional-integral-derivative (PID) controller. To avoid temperature variations throughout a heating chamber of the heating equipment, a fan can be installed and operated within the heating chamber. The fan can circulate air throughout the heating chamber, thereby encouraging mixing of higher and lower temperature regions that may form within the heating chamber (due, for example, to placement of a heating element), and attempting to produce a uniform (or nearly uniform) air temperature adjacent to all outer surfaces of the panel 100 to ensure consistent behavior of the resins in the ballistic sheets. In some examples, the heating chamber can be located within, or can be the same apparatus as, the pressure vessel described herein.

During the heating process, a process temperature can be selected based, at least in part, on a melting point of one or more resins that are incorporated into one or more of the ballistic sheets (e.g. 25) in the stack. For instance, if the stack includes a ballistic sheet containing a thermoplastic polymer resin (e.g. a polyethylene resin) with a melting temperature of about 215-240 degrees F., the process temperature can be increased to about 200-240 degrees F. or beyond to promote softening or melting of the resin in the ballistic sheet. Similarly, if the stack includes a ballistic sheet containing a thermoplastic polymer resin (e.g. a polypropylene resin) with a melting temperature of about 255-295 or 295-330 degrees F., the process temperature can be increased to about 240-295 or about 280-330 degrees F. or beyond to promote softening or melting of the resin in the ballistic sheet.

As noted herein, the panel 100 can include a stack of ballistic sheets 1005 including at least a first plurality of ballistic sheets and a second plurality of ballistic sheets. The first plurality of ballistic sheets can include a first thermoplastic polymer (i.e. first resin) having a first melting point, and the second plurality of ballistic sheets can include a second thermoplastic polymer (i.e. second resin) having a second melting point. The second melting point can be higher than the first melting point. In one example, during the heating process, it can be desirable to heat the panel to a temperature between the first and second melting points, thereby causing melting of the first thermoplastic polymer and resulting in bonding (e.g. partial or full bonding) of each sheet in the first plurality of ballistic sheets to an adjacent sheet. Since the process temperature remains below the second melting point, the second thermoplastic polymer will not melt and the second plurality of ballistic sheets may not undergo any bonding, thereby permitting flexibility of the panel to remain relatively high since the ballistic sheets in the second plurality of ballistic sheets are permitted to move relative to one another when the panel is flexed.

In one example, where the first melting point of the first resin in the first plurality of the ballistic sheets is about 215-240 degrees F. and the second melting point of the second resin in the second plurality of ballistic sheets is about 295-330 degrees F., the process temperature can be about 250-275 or 265-275 degrees F. for at least 15 minutes or for about 60 minutes or more. In another example, where the first melting point of the first resin in the first plurality of the ballistic sheets is about 215-240 degrees F. and the second melting point of the second resin in the second plurality of ballistic sheets is about 255-295 degrees F., the process temperature can be about 200-240 degrees F. for at least 15 minutes or for about 60 minutes or more.

To promote partial or full bonding of adjacent ballistic sheets in the stack, the stack can be heated to a suitable temperature for a suitable duration. Suitable temperatures and durations may depend on the types of resin or resins present in the one or more ballistic sheets in the stack. Examples of suitable process temperatures and durations for a heating process for any of the various stacks of ballistic sheets described herein can include: 200-550 degrees F. for at least 1 second; 200-550 degrees F. for at least 5 minutes; 200-550 degrees F. for at least 15 minutes; 200-550 degrees F. for at least 30 minutes; 200-550 degrees F. for at least 60 minutes; 200-550 degrees F. for at least 90 minutes; 200-550 degrees F. for at least 120 minutes; 200-550 degrees F. for at least 180minutes; 200-550 degrees F. for at least 240 minutes; 200-550 degrees F. for at least 480 minutes; 225-350 degrees F. for at least 1 second; 225-350 degrees F. for at least 5 minutes; 225-350 degrees F. for at least 15 minutes; 225-350 degrees F. for at least 30 minutes; 225-350 degrees F. for at least 60 minutes; 225-350 degrees F. for at least 90 minutes; 225-350 degrees F. for at least 120 minutes; 225-350 degrees F. for at least 180 minutes; 225-350 degrees F. for at least 240 minutes; 250-350 degrees F. for at least 1 second; 250-350 degrees F. for at least 5 minutes; 250-350 degrees F. for at least 15 minutes; 250-350 degrees F. for at least 30 minutes; 250-350 degrees F. for at least 60 minutes; 250-350 degrees F. for at least 90 minutes; 250-350 degrees F. for at least 120 minutes; 250-350 degrees F. for at least 180 minutes; 250-350 degrees F. for at least 240 minutes; 250-300 degrees F. for at least 1 second; 250-300 degrees F. for at least 5 minutes; 250-300 degrees F. for at least 15 minutes; 250-350 degrees F. for at least 30 minutes; 250-300 degrees F. for at least 60 minutes; 250-350 degrees F. for at least 90 minutes; 250-300 degrees F. for at least 120 minutes; 250-300 degrees F. for at least 180 minutes; 250-300 degrees F. for at least 240 minutes; 250-275 degrees F. for at least 1 second; 250-275 degrees F. for at least 5 minutes; 250-275 degrees F. for at least 15 minutes; 250-275 degrees F. for at least 30 minutes; 250-275 degrees F. for at least 60 minutes; 250-275 degrees F. for at least 90 minutes; 250-275 degrees F. for at least 120 minutes; 250-275 degrees F. for at least 180 minutes; 250-275 degrees F. for at least 240 minutes; 265-275 degrees F. for at least 1 second; 265-275 degrees F. for at least 5 minutes; 250-275 degrees F. for at least 15 minutes; 265-275 degrees F. for at least 30 minutes; 265-275 degrees F. for at least 60 minutes; 265-275 degrees F. for at least 90 minutes; 265-275 degrees F. for at least 120 minutes; 265-275 degrees F. for at least 180 minutes; 265-275 degrees F. for at least 240 minutes; 225-250 degrees F. for at least 1 second; 225-250 degrees F. for at least 5 minutes; 225-250 degrees F. for at least 15 minutes; 225-250 degrees F. for at least 30 minutes; 225-250 degrees F. for at least 60 minutes; 225-250 degrees F. for at least 90 minutes; 225-250 degrees F. for at least 120 minutes; 225-250 degrees F. for at least 180 minutes; 225-250 degrees F. for at least 240 minutes; 200-240 degrees F. for at least 1 second; 200-240 degrees F. for at least 5 minutes; 200-240 degrees F. for at least 15 minutes; 200-240 degrees F. for at least 30 minutes; 200-240 degrees F. for at least 60 minutes; 200-240 degrees F. for at least 90 minutes; 200-240 degrees F. for at least 120 minutes; 200-240 degrees F. for at least 180 minutes; or 200-240 degrees F. for at least 240 minutes.

For any of the above-mentioned process temperatures and durations for a heating process, the stack of ballistic sheets 1005 may be sealed within a vacuum bag 1310 during the heating process. In certain examples, a vacuum hose 1305 extending from a vacuum pump can remain connected to a vacuum port 1315 on the vacuum bag 1310 during the heating process, thereby providing a compressive force against the panel 100 during the heating process. This configuration can ensure good results even if the vacuum bag 1310 is not perfectly sealed due to, for example, minor leaks in the bag material or sealant.

Exposing the panel to a higher temperature during the heating process can effectively reduce cycle times, which is desirable for mass production. Due to the thickness of the panel and heat transfer properties of the panel, exposing the panel to a high temperature (e.g. 500 degrees F.) for a relatively short duration may allow the inner portion of the panel to achieve a target temperature needed for bonding (e.g. 250-275 degrees F.) more quickly than if the heat source was initially set to the target temperature needed for bonding.

### Applying Pressure

During formation of the ballistic resistant panel 100, pressure can be applied to the stack of ballistic sheets 1005. Pressure can promote partial or full bonding of adjacent ballistic sheets (e.g. 25) in the stack 1005. Pressure can be applied to the stack of ballistic sheets 1005 using a press (e.g. mechanical pressure), autoclave (e.g. air pressure), hydroclave, bladder press, or other suitable device. In one example, pressure can be applied to the stack of ballistic sheets 1005 during the heating process. In another example, pressure can be applied to the stack of ballistic sheets prior to the heating process. In yet another example, pressure can be applied to the stack of ballistic sheets after the heating process, but while the stack of ballistic sheets is still at an elevated temperature. If pressure is applied to the stack of ballistic sheets, it can occur after the stack of ballistic sheets 1005 has been vacuum bagged and while the stack is still residing inside the vacuum bag 1310 and being heated. Alternately, pressure can be applied to the stack of ballistic sheets 1005 after the stack has been removed from the vacuum bag 1310 or before the stack is inserted into the vacuum bag.

During a process involving both heat and pressure, a process temperature can be selected based on a melting point of one or more thermoplastic polymers (i.e. resins) that are incorporated into one or more of the ballistic sheets in the stack 1005. For instance, if the stack 1005 includes a ballistic sheet (e.g. 25) containing a first resin with a melting temperature of about 215-240 degrees F., the process temperature can be increased to about 200-240 degrees F. or beyond to promote softening or melting of the first resin in the stack. Similarly, if the stack 1005 includes a ballistic sheet containing a second resin with a melting temperature near 255-295 or 295-330 degrees F., the process temperature can be increased to about 240-295 or 280-330 degrees F. or beyond to promote softening or melting of the second resin in the stack.

To promote partial or full bonding of adjacent ballistic sheets (e.g. 25) in the stack 1005, a suitable pressure can be applied to the stack for a suitable duration. Suitable pressures and durations may depend on the types of resin or resins present in the one or more ballistic sheets in the stack. Examples of suitable process pressures and durations for any of the various stacks of ballistic sheets 1005 described herein can include: 10-100 psi for at least 1 second, 10-100 psi for at least 1 second; 10-100 psi for at least 5 minutes; 10-100 psi for at least 15 minutes; 10-100 psi for at least 30 minutes; 10-100 psi for at least 60 minutes; 10-100 psi for at least 90 minutes; 10-100 psi for at least 120 minutes; 10-100 psi for at least 180 minutes; 10-100 psi for at least 240 minutes; 50-75 psi for at least 1 second; 50-75 psi for at least 5 minutes; 50-75 psi for at least 15 minutes; 50-75 psi for at least 30 minutes; 50-75 psi for at least 60 minutes; 50-75 psi for at least 90 minutes; 50-75 psi for at least 120 minutes; 50-75 psi for at least 180 minutes; 50-75 psi for at least 240 minutes; 75-100 psi for at least 1 second; 75-100 psi for at least 5 minutes; 75-100 psi for at least 15 minutes; 75-100 psi for at least 30 minutes; 75-100 psi for at least 60 minutes; 75-100 psi for at least 90 minutes; 75-100 psi for at least 120 minutes; 75-100 psi for at least 180 minutes; 75-100 psi for at least 240 minutes; at least 10 psi for at least 1 second; at least 10 psi for at least 5 minutes; at least 10 psi for at least 15 minutes; at least 10 psi for at least 30 minutes; at least 10 psi for at least 60 minutes; at least 10 psi for at least 90 minutes; at least 100 psi for at least 120 minutes; at least 10 psi for at least 180 minutes; at least 10 psi for at least 240 minutes; at least 100 psi for at least 1 second; at least 100 psi for at least 5 minutes; at least 100 psi for at least 15 minutes; at least 100 psi for at least 30 minutes; at least 100 psi for at least 60 minutes; at least 100 psi for at least 90 minutes; at least 100 psi for at least 120 minutes; at least 100 psi for at least 180 minutes; or at least 100 psi for at least 240 minutes.

Lower pressures may be achievable with, for example, a manual press or a small autoclave. In other examples, higher pressures can be applied to the stack of ballistic sheets with, for example, an industrial autoclave, hydroclave, bladder press (e.g. made of KEVLAR reinforced rubber), a pneumatic press, or a hydraulic press. To promote partial or full bonding of adjacent ballistic sheets in the stack, a suitable pressure can be applied to the stack for a suitable duration or only momentarily. Suitable pressures and durations may depend on the types of resin or resins present in the one or more ballistic sheets in the stack. Examples of suitable process pressures and durations for any of the various stacks of ballistic sheets described herein can include: 100-500 psi for at least 1 second; 100-500 psi for at least 5 minutes; 100-500 psi for at least 15 minutes; 100-500 psi for at least 30 minutes; 100-500 psi for at least 60 minutes; 100-500 psi for at least 90 minutes; 100-500 psi for at least 120 minutes; 100-500 psi for at least 180 minutes; 100-500 psi for at least 240 minutes; 500-1,000 psi for at least 1 second; 500-1,000 psi for at least 5 minutes; 500-1,000 psi for at least 15 minutes; 500-1,000 psi for at least 30 minutes; 500-1,000 psi for at least 60 minutes; 500-1,000 psi for at least 90 minutes; 500-1,000 psi for at least 120 minutes; 500-1,000 psi for at least 180 minutes; 500-1,000 psi for at least 240 minutes; 1,000-2,500 psi for at least 1 second; 1,000-2,500 psi for at least 5 minutes; 1,000-2,500 psi for at least 15 minutes; 1,000-2,500 psi for at least 30 minutes; 1,000-2,500 psi for at least 60 minutes; 1,000-2,500 psi for at least 90 minutes; 1,000-2,500 psi for at least 120 minutes; 1,000-2,500 psi for at least 180 minutes; 1,000-2,500 psi for at least 240 minutes; at least 2,500 psi for at least 1 second; at least 2,500 psi for at least 5 minutes; at least 2,500 psi for at least 15 minutes; at least 2,500 psi for at least 30 minutes; at least 2,500 psi for at least 60 minutes; at least 2,500 psi for at least 90 minutes; at least 2,500 psi for at least 120 minutes; at least 2,500 psi for at least 180 minutes; or at least 2,500 psi for at least 240 minutes.

### Combination of Heat and Pressure

If a process for manufacturing a ballistic panel 100 requires heat and pressure, heat and pressure can be applied simultaneously to reduce the overall cycle time required to manufacture the panel. An autoclave can facilitate these combined processes. An autoclave is a pressure vessel that can be used to apply pressure and heat to one or more ballistic panels 100 during a manufacturing process. If pressure is applied during the heating process, the process temperature can be modified to account for the effect that pressure has on the melting point of the one or more resins that are incorporated in one or more of the ballistic sheets in the stack 1005. For instance, if the melting point of the resin increases as pressure increases, the target process temperature for the heating process can be increased when the heating process occurs in conjunction with the pressure process to ensure melting of the resin.

### 3-Dimensional Forming Process

During a forming process, a mold can be used to transform a flat ballistic resistant panel 100 into any suitable 3-dimensional shape. In one example, the forming process can occur concurrently with the vacuum bagging process. In another example, pressure, such as air pressure within an autoclave, can be used to form the ballistic resistant panel into any suitable 3-dimensional shape while the panel 100 is still in the vacuum bag 1310. In yet another example, pressure, such as air pressure within an autoclave, and heat can be used to form the ballistic resistant panel 100 into any suitable 3-dimensional shape while the panel 100 is still in the vacuum bag 1310. In still another example, the panel 100 may be inserted into a mold while still at an elevated temperature following the heating process, and a press can be used to conform the panel to the shape of the mold.

### Heat Sealing

As discussed above, the stack of ballistic sheets 1005 can be encased in a protective cover 1105. The outer perimeter of the cover 1105 can be heat-sealed to prevent water ingress. Heat sealing is a process where one material is joined to another material (e.g. one thermoplastic is joined to another thermoplastic) using heat and pressure. During the heat sealing process, a heated die or sealing bar can apply heat and pressure to a specific contact area or path to seal or join two materials together. When heat-sealing the perimeter of the cover, the presence of a thermoplastic material proximate the contact area can promote sealing in the presence of heat and pressure. In one example, the cover 1105 can include thermoplastic polyurethane proximate the contact area to permit heat sealing. The cover 1105 can be made of a first portion and a second portion, and the heat sealing process can be used to join the first portion to the second portion, thereby encapsulating the stack of ballistic sheets 1005 in a waterproof enclosure.

### Cooling

After the stack of ballistic sheets 1005 has been heated to a predetermined temperature for a predetermined duration, the stack can be cooled. In one example, the cooling process can occur while the stack of ballistic sheets is outside of the vacuum bag 1310. In another example, the cooling process can occur while the stack of ballistic sheets 1005 is inside the vacuum bag with vacuum applied. During the cooling process, the temperature of the stack of ballistic sheets 1005 can be reduced from the predetermined temperature to about room temperature. Cooling can occur through natural convection, forced convection, liquid cooling, or any other suitable cooling process. If liquid cooling is employed, a suitable spray cooling process can be employed. Alternately, the stack of ballistic sheets 1005 encased in the waterproof cover 1105 can be submerged in a water bath. The water bath can be connected to a heat exchanger and a circulating pump to increase the rate of cooling.

### Break-In Process

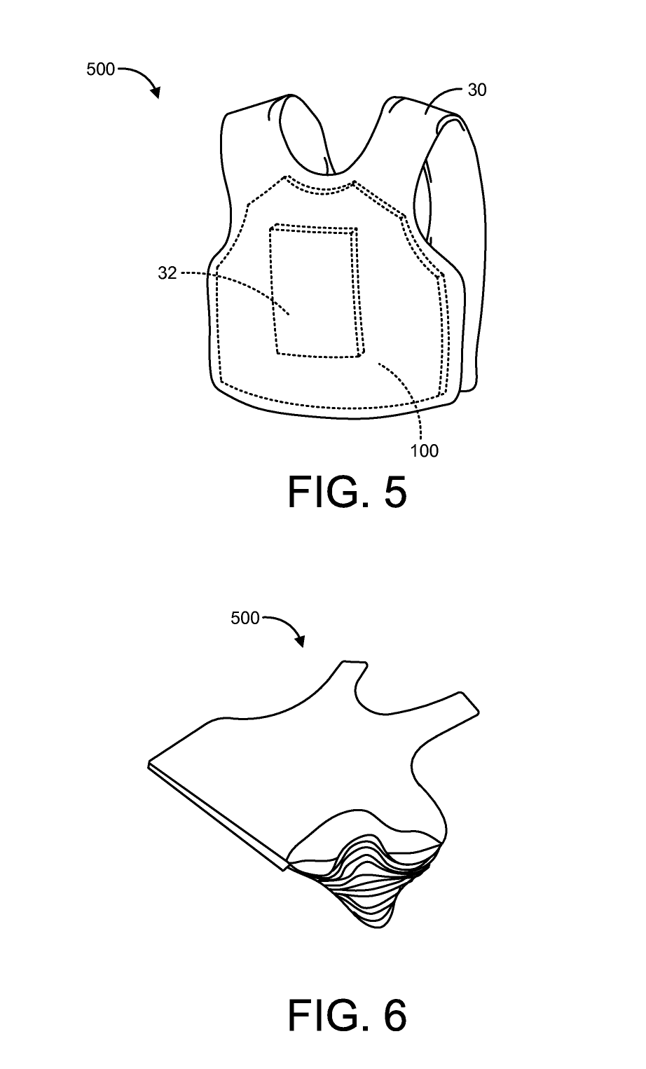

For certain applications, it is desirable to manufacture a ballistic panel 100 that is relatively flexible. For instance, when the panel is intended for use in a personal garment, such as a bullet-proof vest 30 as shown in FIG. 5, it can be desirable to use a flexible panel 100 that provides the wearer greater mobility. Panels that are relatively flexible are generally referred to as “soft armor,” whereas panels that are relatively rigid, such as a steel or ceramic plate 32 shown in FIG. 5 are generally referred to as “hard armor.” To further improve the flexibility of the soft armor panels described herein, the panels can be subjected to a break-in process. The break-in process can be accomplished by hand or by mechanical devices. Mechanical devices can be used to speed the break-in process and to provide greater consistency among a series of panels, thereby improving quality control and ensuring consistent panel performance. In one example, a series of rollers can be configured to receive the flexible panel 100. As the panel 100 passes through a first set of rollers, the panel may be deformed in a first direction to transform the nearly flat panel to a curved panel. Due to the resilience of the stack of ballistic sheets, the panel 100 may return to a nearly flat panel shortly after exiting the first set of rollers. The panel 100 may then pass through a second set of rollers configured to deform the panel in a second direction that is opposite the first direction. Once again, due to the resilience of the stack of ballistic sheets, the panel may return to a nearly flat panel shortly after exiting the second set of rollers. To further enhance the flexibility of the panel, the panel may be fed through the first and second rollers one or more additional times.

### Methods for Cutting Ballistic Sheets

The intended use of the ballistic panel 100 will affect the size and shape of the panel, and the size and shape of the panel will dictate the geometry of a pattern (e.g. two-dimensional pattern) that is cut from the ballistic sheet 25. The intended use of the panel will also dictate how many ballistic sheets should be included in the panel to satisfy certain performance standards, such as those set forth in NIJ Standard-0101.06.

In one example, ballistic sheets 25 can be cut from large rolls of ballistic sheet material. Due to the size of the sheets, it is common for one or more patterns be cut from a single ballistic sheet. The patterns can be arranged on the ballistic sheet to minimize the amount of ballistic sheet material that is wasted. In one example, a computer program can be used to determine an arrangement of patterns that minimizes the amount of wasted ballistic sheet material.

The ballistic sheets 25 can be cut on a cutting table, such as a model M9000 manufactured by Eastman Machine Company of Buffalo, N.Y. The top surface of the cutting table can include a plurality of holes. The cutting table can be connected to a vacuum pump that applies suction to a lower side of the top surface, thereby drawing air through the plurality of holes and creating suction proximate the top surface of the cutting table. During cutting, the ballistic material can be placed on the cutting table. The suction can assist in preventing movement of the ballistic sheet relative to the cutting table during the cutting process, which can improve cutting performance and precision and reduce the quantity of wasted material. Employing a cutting table with a vacuum system can reduce fraying of fibers at a cutting location by avoiding unwanted movement of the ballistic sheet during the cutting process.

The top surface of the cutting table can be made of any suitable material. In one example, the top surface of the cutting table can be made of POREX, a porous polymer material. POREX can be costly to replace if damaged by a cutting process or through misuse. A less expensive polymer sheet can be used to cover and protect the POREX. For instance, a LEXAN sheet can be used to cover and protect the POREX surface. The LEXAN sheet can include a plurality of holes that permit air to pass through the sheet and allow suction to be created proximate a top surface of the LEXAN sheet. If the LEXAN sheet is damaged during a cutting process, it can be replaced at a much lower cost than POREX. Due to its machinability, the LEXAN sheet can permit an operator to easily drill or create any suitable hole pattern in the LEXAN sheet. The number, size, or configuration of the plurality holes can vary depending on the pattern to be cut from the ballistic sheet. This provides the operator with additional process flexibility that can enhance cutting performance (e.g. the LEXAN sheet can be modified to intentionally cover and obstruct certain pores in the POREX, thereby increasing the suction proximate the remaining unobstructed pores). If the operator is cutting two patterns on the same cutting table in a single day, the operator can have two LEXAN sheets that are each optimized for cutting one of the two patterns. For instance, a first LEXAN sheet can have a number, size, and configuration of holes that is optimized for a first pattern, and a second LEXAN sheet can have a number, size, and configuration of holes that is optimized for a second pattern.

### Methods for Cutting a Plurality of Ballistic Sheets

To increase efficiency, it can be desirable to cut a pattern from two or more ballistic sheets simultaneously. This can be accomplished by stacking two or more ballistic sheets prior to cutting the sheets. Cutting can be accomplished on a cutting table with any suitable cutting tool, such as a laser, blade, rotary knife, or die cutter. In one example the cutting tool can be a drag knife mounted to a computer controlled gantry. When a drag knife is used, a downward cutting force from the drag knife is applied against the stack of ballistic sheets and, in turn, against the top surface of the cutting table (or LEXAN sheet covering the cutting table).

If two or more types of ballistic sheets are being cut simultaneously in a stack, the resulting cut quality of each ballistic sheet can depend on the arrangement of the ballistic sheets within the stack. Certain types of ballistic sheets that are less stiff exhibit poor cut quality if placed on top of the stack. For instance, ballistic sheets that are less stiff may suffer poor cut quality, such as fraying along their edges or fibers pulling from the sheets by the drag knife, which can compromise the ballistic performance of the sheets.

However, it has been discovered through experimentation that bounding ballistic sheets that are less stiff with ballistic sheets that are stiffer can provide better cut quality along an edge of the less stiff ballistic sheet and produce significantly less fraying or pulling of fibers at the edge of the less stiff ballistic sheet. In one example, a grouping of one or more ballistic sheets that are less stiff can be bounded on a top surface by a grouping of one or more ballistic sheets that are stiffer. Specifically, a stack of ballistic sheets that is suitable for cutting on a cutting table can include a first grouping of one or more stiffer ballistic sheets on top of a second grouping of one or more less stiff ballistic sheets. In another example, a grouping of one or more ballistic sheets that are less stiff can be bounded on a top surface and a bottom surface by grouping of one or more ballistic sheets that are stiffer. Specifically, a stack of ballistic sheets that is suitable for cutting on a cutting table can include a first grouping of one or more stiffer ballistic sheets, a second grouping of one or more less stiff ballistic sheets, and a third grouping of one or more stiffer ballistic sheets.

The flexibility of commercially available ballistic sheets varies. In relative terms, K-FLEX ballistic sheets can be less stiff than THERMOBALLISTIC ballistic sheets. K-FLEX ballistic sheets can have a stiffness similar to fabric used for garments, whereas THERMOBALLISTIC ballistic sheets can have a stiffness similar to a paper business card. When cutting one or more K-FLEX ballistic sheets, cutting performance can be enhanced by grouping the one or more K-FLEX ballistic sheets with one or more THERMOBALLISTIC ballistic sheets, where the one or more THERMOBALLISTIC ballistic sheets are either on a top side only or on both a top and bottom side of the one or more K-FLEX ballistic sheets. These groupings of ballistic sheets can provide cleaner cuts with less fraying along edges of the K-FLEX ballistic sheets. Reducing fraying along edges of the cut sheets can help ensure that the performance of the sheets is not degraded and, ultimately, that the resulting ballistic panel 100 performs as intended.

Examples of stacks of ballistic sheets suitable for cutting on a cutting table include the following configurations, where the first listed grouping in each stack is in closest proximity to the top surface of the cutting table, and the last listed grouping in each stack is farthest from the top surface of the cutting table: 1-6 THERMOBALLISTIC 0/90 x-ply ballistic sheets, 1-10 K-FLEX 0/90 x-ply ballistic sheets, 1-6 THERMOBALLISTIC 0/90 x-ply ballistic sheets; 1-5 THERMOBALLISTIC 0/90 x-ply ballistic sheets, 1-10 K-FLEX 0/90 x-ply ballistic sheets, 1-5 THERMOBALLISTIC 0/90 x-ply ballistic sheets; 1-4 THERMOBALLISTIC 0/90 x-ply ballistic sheets, 1-10 K-FLEX 0/90 x-ply ballistic sheets, 1-4 THERMOBALLISTIC 0/90 x-ply ballistic sheets; 1-3 THERMOBALLISTIC 0/90 x-ply ballistic sheets, 1-10 K-FLEX 0/90 x-ply ballistic sheets, 1-3 THERMOBALLISTIC 0/90 x-ply ballistic sheets; 1-2 THERMOBALLISTIC 0/90 x-ply ballistic sheets, 1-10 K-FLEX 0/90 x-ply ballistic sheets, 1-2 THERMOBALLISTIC 0/90 x-ply ballistic sheets; 1 THERMOBALLISTIC 0/90 x-ply ballistic sheets, 1-10 K-FLEX 0/90 x-ply ballistic sheets, 1 THERMOBALLISTIC 0/90 x-ply ballistic sheets; 6 THERMOBALLISTIC 0/90 x-ply ballistic sheets, 10 K-FLEX 0/90 x-ply ballistic sheets, 6 THERMOBALLISTIC 0/90 x-ply ballistic sheets; 6 THERMOBALLISTIC 0/90 x-ply ballistic sheets, 8 K-FLEX 0/90 x-ply ballistic sheets, 6 THERMOBALLISTIC 0/90 x-ply ballistic sheets; or 1 or more THERMOBALLISTIC 0/90 x-ply ballistic sheets, 1 or more K-FLEX 0/90 x-ply ballistic sheets, 1 or more THERMOBALLISTIC 0/90 x-ply ballistic sheets.

Additional examples of stacks of ballistic sheets suitable for cutting on a cutting table are provided below, where a first plurality of ballistic sheets (e.g. one or more K-FLEX 0/90 x-ply ballistic sheets) are bounded by a second plurality of ballistic sheets (e.g. one or more THERMOBALLISTIC 0/90 x-ply ballistic sheets). In the following examples, the first listed grouping in each stack is in closest proximity to the top surface of the cutting table: 1-6 K-FLEX 0/90 x-ply ballistic sheets, 1-6 THERMOBALLISTIC 0/90 x-ply ballistic sheets; 1-4 K-FLEX 0/90 x-ply ballistic sheets, 1-6 THERMOBALLISTIC 0/90 x-ply ballistic sheets; 2-4 K-FLEX 0/90 x-ply ballistic sheets, 3-6 THERMOBALLISTIC 0/90 x-ply ballistic sheets; 3-4 K-FLEX 0/90 x-ply ballistic sheets; 4-6 THERMOBALLISTIC 0/90 x-ply ballistic sheets; 3 K-FLEX 0/90 x-ply ballistic sheets, 6 THERMOBALLISTIC 0/90 x-ply ballistic sheets; 4 K-FLEX 0/90 x-ply ballistic sheets, 6 THERMOBALLISTIC 0/90 x-ply ballistic sheets.

### Homogeneous or Non-Homogeneous Stack

In one example, the ballistic sheets can be arranged in a homogeneous stack, where all ballistic sheets in the stack are made from the same type of ballistic sheet material. In other examples, any of the others suitable types of ballistic sheets (e.g. sheets made of aramid or glass fibers, sheets made of ceramic, or sheets made of metal) can be interspersed in the stack of ballistic sheet material to improve the ballistic performance of the stack. In another example, a sheet of film adhesive, such as a sheet of film adhesive available from Collano A G, located in Germany, can be interspersed in the stack of ballistic sheets to alter the ballistic performance of the stack. In particular, a sheet of adhesive film can be incorporated within the stack near a strike face side of the stack to improve stab resistance of the panel. A sheet of adhesive film can be incorporated within the stack near a wear face side of the stack to reduce back face deformation of the panel after being struck by a projectile.

Panels Constructed from X-Ply Ballistic Sheets

Two uni-ply ballistic sheets can be bonded together to produce a configuration known as x-ply. Examples of suitable stacks of x-ply ballistic sheets 1005 for a flexible ballistic resistant panel 100 can include a first plurality of x-ply ballistic sheets 1020 containing a first resin with a first melting temperature and a second plurality of x-ply ballistic sheets 1025 containing a second resin with a second melting temperature (see, e.g. FIGS. 11 and 12). The second melting temperature can be higher than the first melting temperature. Examples include: 1-10 0/90 x-ply ballistic sheets containing a first resin and 1-10 0/90 x-ply ballistic sheets containing a second resin; 4-10 0/90 x-ply ballistic sheets containing a first resin and 4-10 0/90 x-ply ballistic sheets containing a second resin; 6-10 0/90 x-ply ballistic sheets containing a first resin and 6-10 0/90 x-ply ballistic sheets containing a second resin; 10-20 0/90 x-ply ballistic sheets containing a first resin and 10-20 0/90 x-ply ballistic sheets containing a second resin; 20-30 0/90 x-ply ballistic sheets containing a first resin and 20-30 0/90 x-ply ballistic sheets containing a second resin.

Examples of suitable stacks of x-ply ballistic sheets 1005 containing aramid fibers can include a first plurality of x-ply ballistic sheets 1020 containing aramid fibers and a first resin with a first melting temperature and a second plurality of x-ply ballistic sheets 1025 containing aramid fibers and a second resin with a second melting temperature (see, e.g. FIGS. 11 and 12). The second melting temperature can be higher than the first melting temperature. Examples include: 1-10 0/90 x-ply ballistic sheets containing a first resin and 1-10 0/90 x-ply ballistic sheets containing a second resin; 4-10 0/90 x-ply ballistic sheets containing a first resin and 4-10 0/90 x-ply ballistic sheets containing a second resin; 6-10 0/90 x-ply ballistic sheets containing a first resin and 6-10 0/90 x-ply ballistic sheets containing a second resin; 10-20 0/90 x-ply ballistic sheets containing a first resin and 10-20 0/90 x-ply ballistic sheets containing a second resin; 20-30 0/90 x-ply ballistic sheets containing a first resin and 20-30 0/90 x-ply ballistic sheets containing a second resin.

Examples of suitable stacks of x-ply ballistic sheets 1005 for a flexible ballistic panel 100 can include a first plurality of x-ply ballistic sheets 1020 containing a polyethylene resin with a melting temperature of about 215-240 degrees F. and a second plurality of x-ply ballistic sheets 1025 containing a polypropylene resin with a melting temperature of about 255-295 or 295-330 F (see, e.g. FIGS. 11 and 12). Examples include: 1-10 0/90 x-ply ballistic sheets containing a polyethylene resin and 1-10 0/90 x-ply ballistic sheets containing a polypropylene resin; 4-10 0/90 x-ply ballistic sheets containing a polyethylene resin and 4-10 0/90 x-ply ballistic sheets containing a polypropylene resin; 6-10 0/90 x-ply ballistic sheets containing a polyethylene resin and 6-10 0/90 x-ply ballistic sheets containing a polypropylene resin; 10-20 0/90 x-ply ballistic sheets containing a polyethylene resin and 10-20 0/90 x-ply ballistic sheets containing a polypropylene resin; 20-30 0/90 x-ply ballistic sheets containing a polyethylene resin and 20-30 0/90 x-ply ballistic sheets containing a polypropylene resin.

Examples of suitable stacks of x-ply ballistic sheets 1005 for a flexible ballistic panel 100 can include a first plurality of THERMOBALLISTIC ballistic sheets 1025 arranged in a stack having a top surface and a bottom surface and bounded on the top surface by a first plurality of K-FLEX ballistic sheets 1020 and bounded on the bottom surface by a second plurality of K-FLEX ballistic sheets 1030, as shown in FIG. 11. Examples include: 1-10 K-FLEX 0/90 x-ply ballistic sheets, 1-10 THERMOBALLISTIC 0/90 x-ply ballistic sheets, 1-10 K-FLEX 0/90 x-ply ballistic sheets; 4-10 K-FLEX 0/90 x-ply ballistic sheets, 4-10 THERMOBALLISTIC 0/90 x-ply ballistic sheets, 4-10 K-FLEX 0/90 x-ply ballistic sheets; 6-10 K-FLEX 0/90 x-ply ballistic sheets, 6-10 THERMOBALLISTIC 0/90 x-ply ballistic sheets, 6-10 K-FLEX 0/90 x-ply ballistic sheets; 8 K-FLEX 0/90 x-ply ballistic sheets, 10 THERMOBALLISTIC 0/90 x-ply ballistic sheets, 8 K-FLEX 0/90 x-ply ballistic sheets; 6 K-FLEX 0/90 x-ply ballistic sheets, 8 THERMOBALLISTIC 0/90 x-ply ballistic sheets, 6 K-FLEX 0/90 x-ply ballistic sheets; 5 K-FLEX 0/90 x-ply ballistic sheets, 8 THERMOBALLISTIC 0/90 x-ply ballistic sheets, 5 K-FLEX 0/90 x-ply ballistic sheets; 4 K-FLEX 0/90 x-ply ballistic sheets, 8 THERMOBALLISTIC 0/90 x-ply ballistic sheets, 4 K-FLEX 0/90 x-ply ballistic sheets; 10-20 K-FLEX 0/90 x-ply ballistic sheets, 10-20 THERMOBALLISTIC 0/90 x-ply ballistic sheets, 10-20 K-FLEX 0/90 x-ply ballistic sheets; or 20-30 K-FLEX 0/90 x-ply ballistic sheets, 20-30 THERMOBALLISTIC 0/90 x-ply ballistic sheets, 20-30 K-FLEX 0/90 x-ply ballistic sheets.

Examples of suitable stacks of x-ply ballistic sheets 1005 for a flexible ballistic panel 100 can include a first plurality of K-FLEX ballistic sheets 1025 arranged in a stack having a top surface and a bottom surface and bounded on the top surface by a first plurality of THERMOBALLISTIC ballistic sheets 1020 and bounded on the bottom surface by a second plurality of THERMOBALLISTIC ballistic sheets 1030, as shown in FIG. 12. Suitable examples include: 1-10 THERMOBALLISTIC 0/90 x-ply ballistic sheets, 1-10 K-FLEX 0/90 x-ply ballistic sheets, 1-10 THERMOBALLISTIC 0/90 x-ply ballistic sheets; 4-10 THERMOBALLISTIC 0/90 x-ply ballistic sheets, 4-10 K-FLEX 0/90 x-ply ballistic sheets, 4-10 THERMOBALLISTIC 0/90 x-ply ballistic sheets; 6-10 THERMOBALLISTIC 0/90 x-ply ballistic sheets, 6-10 K-FLEX 0/90 x-ply ballistic sheets, 6-10 THERMOBALLISTIC 0/90 x-ply ballistic sheets; 8 THERMOBALLISTIC 0/90 x-ply ballistic sheets, 10 K-FLEX 0/90 x-ply ballistic sheets, 8 THERMOBALLISTIC 0/90 x-ply ballistic sheets; 6 THERMOBALLISTIC 0/90 x-ply ballistic sheets, 8 THERMOBALLISTIC 0/90 x-ply ballistic sheets, 6 THERMOBALLISTIC 0/90 x-ply ballistic sheets; 5 THERMOBALLISTIC 0/90 x-ply ballistic sheets, 8 K-FLEX 0/90 x-ply ballistic sheets, 5 THERMOBALLISTIC 0/90 x-ply ballistic sheets; 4 THERMOBALLISTIC 0/90 x-ply ballistic sheets, 8 K-FLEX 0/90 x-ply ballistic sheets, 4 THERMOBALLISTIC 0/90 x-ply ballistic sheets; 6 THERMOBALLISTIC 0/90 x-ply ballistic sheets, 6 K-FLEX 0/90 x-ply ballistic sheets, 6 THERMOBALLISTIC 0/90 x-ply ballistic sheets; 10-20 THERMOBALLISTIC 0/90 x-ply ballistic sheets, 10-20 K-FLEX 0/90 x-ply ballistic sheets, 10-20 THERMOBALLISTIC 0/90 x-ply ballistic sheets, or 20-30 THERMOBALLISTIC 0/90 x-ply ballistic sheets, 20-30 K-FLEX 0/90 x-ply ballistic sheets, 20-30 THERMOBALLISTIC 0/90 x-ply ballistic sheets.

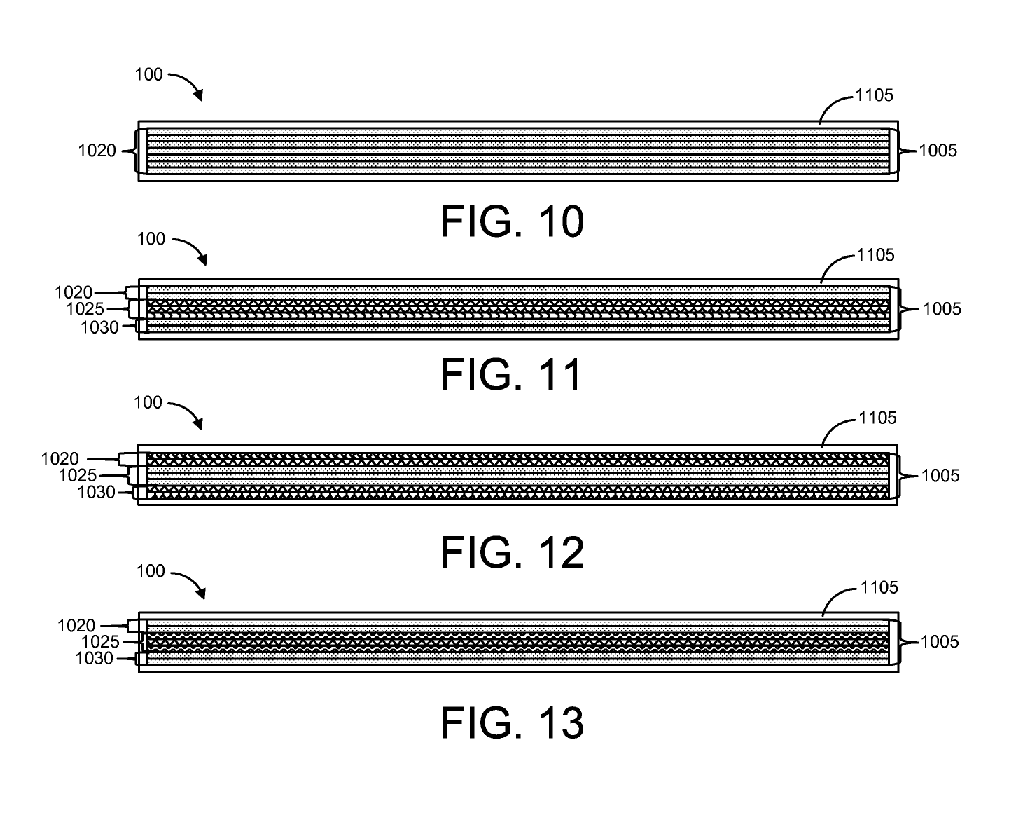

Examples of suitable stacks of x-ply ballistic sheets 1005 for a ballistic panel 100 can include a grouping of 1-10, 4-10, 6-10, 10-20, or 20-30 x-ply ballistic sheets 1005 made of fibers (such as, for example, aramid fibers or UHMWPE fibers), as shown in FIG. 10. Examples of suitable stacks of x-ply ballistic sheets 1005 for a ballistic panel 100 can include a grouping of 1-10, 4-10, 6-10, 10-20, or 20-30 THERMOBALLISTIC 0/90 x-ply ballistic sheets. Other examples of suitable stacks 1005 of x-ply ballistic sheets for a ballistic panel 100 can include a grouping of 1-10, 4-10, 6-10, 10-20 or 20-30 K-FLEX 0/90 x-ply ballistic sheets.

Panels Constructed from Uni-Ply Ballistic Sheets

Examples of suitable stacks of uni-ply ballistic sheets 1005 for a flexible ballistic resistant panel 100 can include a first plurality of uni-ply ballistic sheets 1020 containing a first resin with a first melting temperature and a second plurality of uni-ply ballistic sheets 1025 containing a second resin with a second melting temperature (see, e.g. FIGS. 11 and 12). The second melting temperature can be higher than the first melting temperature. Examples include: 1-10 0/90 uni-ply ballistic sheets containing a first resin and 1-10 0/90 uni-ply ballistic sheets containing a second resin; 4-10 0/90 uni-ply ballistic sheets containing a first resin and 4-10 0/90 uni-ply ballistic sheets containing a second resin; 6-10 0/90 uni-ply ballistic sheets containing a first resin and 6-10 0/90 uni-ply ballistic sheets containing a second resin; 10-20 0/90 uni-ply ballistic sheets containing a first resin and 10-20 0/90 uni-ply ballistic sheets containing a second resin; 20-30 0/90 uni-ply ballistic sheets containing a first resin and 20-30 0/90 uni-ply ballistic sheets containing a second resin.

Examples of suitable stacks of uni-ply ballistic sheets containing aramid fibers can include a first plurality of uni-ply ballistic sheets 1020 containing aramid fibers and a first resin with a first melting temperature and a second plurality of uni-ply ballistic sheets 1025 containing aramid fibers and a second resin with a second melting temperature (see, e.g. FIGS. 11 and 12). The second melting temperature can be higher than the first melting temperature. Examples include: 1-10 uni-ply ballistic sheets containing a first resin and 1-10 uni-ply ballistic sheets containing a second resin; 8-20 uni-ply ballistic sheets containing a first resin and 8-20 uni-ply ballistic sheets containing a second resin; 12-20 uni-ply ballistic sheets containing a first resin and 12-20 uni-ply ballistic sheets containing a second resin; 20-40 uni-ply ballistic sheets containing a first resin and 20-40 uni-ply ballistic sheets containing a second resin; 40-60 uni-ply ballistic sheets containing a first resin and 40-60 uni-ply ballistic sheets containing a second resin.

Examples of suitable stacks of uni-ply ballistic sheets 1005 for flexible ballistic resistant panels 100 can include a first plurality of uni-ply ballistic sheets 1020 containing a polyethylene resin with a melting temperature of about 215-240 degrees F. and a second plurality of uni-ply ballistic sheets 1025 containing a polypropylene resin with a melting temperature of about 255-295 or 295-330 F (see, e.g. FIGS. 11 and 12). Examples include: 1-10 uni-ply ballistic sheets containing a polyethylene resin and 1-10 0/90 uni-ply ballistic sheets containing a polypropylene resin; 8-20 uni-ply ballistic sheets containing a polyethylene resin and 8-20 uni-ply ballistic sheets containing a polypropylene resin; 12-20 uni-ply ballistic sheets containing a polyethylene resin and 12-20 uni-ply ballistic sheets containing a polypropylene resin; 20-40 uni-ply ballistic sheets containing a polyethylene resin and 20-40 uni-ply ballistic sheets containing a polypropylene resin; 40-60 uni-ply ballistic sheets containing a polyethylene resin and 40-60 uni-ply ballistic sheets containing a polypropylene resin.

Examples of suitable stacks of uni-ply ballistic sheets 1005 for a flexible ballistic resistant panel 100 can include a first plurality of THERMOBALLISTIC ballistic sheets 1025 arranged in a stack having a top surface and a bottom surface and bounded on the top surface by a first plurality of K-FLEX ballistic sheets 1020 and bounded on the bottom surface by a second plurality of K-FLEX ballistic sheets 1030, as shown in FIG. 11. Examples include: 2-20 K-FLEX uni-ply ballistic sheets, 2-20 THERMOBALLISTIC uni-ply ballistic sheets, 2-20 K-FLEX uni-ply ballistic sheets; 8-20 K-FLEX uni-ply ballistic sheets, 8-20 THERMOBALLISTIC uni-ply ballistic sheets, 8-20 K-FLEX uni-ply ballistic sheets; 12-20 K-FLEX uni-ply ballistic sheets, 12-20 THERMOBALLISTIC uni-ply ballistic sheets, 12-20 K-FLEX uni-ply ballistic sheets; 16 K-FLEX uni-ply ballistic sheets, 20 THERMOBALLISTIC uni-ply ballistic sheets, 16 K-FLEX uni-ply ballistic sheets; 12 K-FLEX uni-ply ballistic sheets, 16 THERMOBALLISTIC uni-ply ballistic sheets, 12 K-FLEX uni-ply ballistic sheets; 10 K-FLEX uni-ply ballistic sheets, 16 THERMOBALLISTIC uni-ply ballistic sheets, 10 K-FLEX uni-ply ballistic sheets; 8 K-FLEX uni-ply ballistic sheets, 16 THERMOBALLISTIC uni-ply ballistic sheets, 8 K-FLEX uni-ply ballistic sheets; 20-40 K-FLEX uni-ply ballistic sheets, 20-40 THERMOBALLISTIC uni-ply ballistic sheets, 20-40 K-FLEX uni-ply ballistic sheets; or 40-60 K-FLEX uni-ply ballistic sheets, 40-60 THERMOBALLISTIC uni-ply ballistic sheets, 40-60 K-FLEX uni-ply ballistic sheets. In the stacks listed above, adjacent unidirectional ballistic sheets can be oriented to simulate 0/90 x-ply. For instance, in a stack of four sheets of uni-ply, a first sheet can be oriented at 0 degrees, a second sheet can be oriented at 90 degrees, a third sheet can be oriented at 0 degrees, and a fourth sheet can be oriented at 90 degrees.

Examples of suitable stacks of uni-ply ballistic sheets 1005 can include a first plurality of K-FLEX ballistic sheets 1025 arranged in a stack having a top surface and a bottom surface and bounded on the top surface by a first plurality of THERMOBALLISTIC ballistic sheets 1020 and bounded on the bottom surface by a second plurality of THERMOBALLISTIC ballistic sheets 1030, as shown in FIG. 12. Suitable examples include: 2-20 THERMOBALLISTIC uni-ply ballistic sheets, 2-20 K-FLEX uni-ply ballistic sheets, 2-20 THERMOBALLISTIC uni-ply ballistic sheets; 8-20 THERMOBALLISTIC uni-ply ballistic sheets, 8-20 K-FLEX uni-ply ballistic sheets, 8-20 THERMOBALLISTIC uni-ply ballistic sheets; 12-20 THERMOBALLISTIC uni-ply ballistic sheets, 12-20 K-FLEX uni-ply ballistic sheets, 12-20 THERMOBALLISTIC uni-ply ballistic sheets; 16 THERMOBALLISTIC uni-ply ballistic sheets, 20 K-FLEX uni-ply ballistic sheets, 16 THERMOBALLISTIC uni-ply ballistic sheets; 12 THERMOBALLISTIC uni-ply ballistic sheets, 16 K-FLEX uni-ply ballistic sheets, 12 THERMOBALLISTIC uni-ply ballistic sheets; 10 THERMOBALLISTIC uni-ply ballistic sheets, 16 K-FLEX uni-ply ballistic sheets, 10 THERMOBALLISTIC uni-ply ballistic sheets; 8 THERMOBALLISTIC uni-ply ballistic sheets, 16 K-FLEX uni-ply ballistic sheets, 8 THERMOBALLISTIC uni-ply ballistic sheets; 20-40 THERMOBALLISTIC uni-ply ballistic sheets, 20-40 K-FLEX uni-ply ballistic sheets, 20-40 THERMOBALLISTIC uni-ply ballistic sheets; or 40-60 THERMOBALLISTIC uni-ply ballistic sheets, 40-60 K-FLEX uni-ply ballistic sheets, 40-60 THERMOBALLISTIC uni-ply ballistic sheets. In the stacks listed above, adjacent unidirectional ballistic sheets can be oriented to simulate 0/90 x-ply. For instance, in a stack of four sheets of uni-ply, a first sheet can be oriented at 0 degrees, a second sheet can be oriented at 90 degrees, a third sheet can be oriented at 0 degrees, and a fourth sheet can be oriented at 90 degrees.

Examples of suitable stacks of unidirectional ballistic sheets 1005 for a flexible ballistic resistant panel 100 can include a grouping of 2-20, 8-20, 12-20, 20-40, or 40-60 unidirectional ballistic sheets made of fibers such as, for example, aramid or UHMWPE fibers. Examples of suitable stacks of unidirectional ballistic sheets 1005 for a ballistic panel 100 can include a grouping of 2-20, 8-20, 12-20, 20-40, or 40-60 unidirectional THERMOBALLISTIC ballistic sheets. Other examples of suitable stacks of unidirectional ballistic sheets 1005 for a ballistic panel 100 can include a grouping of 2-20, 8-20, 12-20, 20-40, or 40-60 unidirectional K-FLEX ballistic sheets. Still other examples of suitable stacks of unidirectional ballistic sheets 1005 for a ballistic panel 100 can include a grouping of 2-20, 8-20, 12-20, 20-40, or 40-60 TENSYLON ballistic sheets.

Panels Constructed from Double X-Ply Ballistic Sheets

Two x-ply ballistic sheets can be bonded together to produce a configuration known as double x-ply. Examples of suitable stacks of double x-ply ballistic sheets 1005 for a flexible ballistic resistant panel 100 can include a first plurality of double x-ply ballistic sheets 1020 containing a first resin with a first melting temperature and a second plurality of double x-ply ballistic sheets 1025 containing a second resin with a second melting temperature (see, e.g., FIGS. 11 and 12). The second melting temperature can be higher than the first melting temperature. Examples include: 1-10 0/90/0/90 double x-ply ballistic sheets containing a first resin and 1-10 0/90/0/90 double x-ply ballistic sheets containing a second resin; 4-10 0/90/0/90 double x-ply ballistic sheets containing a first resin and 4-10 0/90/0/90 double x-ply ballistic sheets containing a second resin; 6-10 0/90 x-ply ballistic sheets containing a first resin and 6-10 0/90/0/90 double x-ply ballistic sheets containing a second resin; 10-15 0/90/0/90 double x-ply ballistic sheets containing a first resin and 10-15 0/90/0/90 double x-ply ballistic sheets containing a second resin; 15-20 0/90/0/90 double x-ply ballistic sheets containing a first resin and 15-20 0/90/0/90 double x-ply ballistic sheets containing a second resin.

Examples of suitable stacks of double x-ply ballistic sheets 1005 containing aramid fibers can include a first plurality of double x-ply ballistic sheets containing aramid fibers and a first resin with a first melting temperature and a second plurality of double x-ply ballistic sheets containing aramid fibers and a second resin with a second melting temperature (see, e.g., FIGS. 11 and 12). The second melting temperature can be higher than the first melting temperature. Examples include: 1-10 0/90/0/90 double x-ply ballistic sheets containing a first resin and 1-10 0/90/0/90 double x-ply ballistic sheets containing a second resin; 4-10 0/90/0/90 double x-ply ballistic sheets containing a first resin and 4-10 0/90/0/90 double x-ply ballistic sheets containing a second resin; 6-10 0/90/0/90 double x-ply ballistic sheets containing a first resin and 6-10 0/90/0/90 double x-ply ballistic sheets containing a second resin; 10-15 0/90/0/90 double x-ply ballistic sheets containing a first resin and 10-15 0/90 x-ply ballistic sheets containing a second resin; 15-20 0/90/0/90 double x-ply ballistic sheets containing a first resin and 15-20 0/90/0/90 double x-ply ballistic sheets containing a second resin.

Examples of suitable stacks of double x-ply ballistic sheets 1005 for a flexible ballistic resistant panel 100 can include a first plurality of double x-ply ballistic sheets 1020 containing a polyethylene resin with a melting temperature of about 215-240 degrees F. and a second plurality of double x-ply ballistic sheets 1025 containing a polypropylene resin with a melting temperature of about 255-295 or 295-330 F. (see, e.g., FIGS. 11 and 12). Examples include: 1-10 0/90/0/90 double x-ply ballistic sheets containing a polyethylene resin and 1-10 0/90/0/90 double x-ply ballistic sheets containing a polypropylene resin; 4-10 0/90/0/90 double x-ply ballistic sheets containing a first resin and 4-10 0/90/0/90 double x-ply ballistic sheets containing a polypropylene resin; 6-10 0/90/0/90 double x-ply ballistic sheets containing a polyethylene resin and 6-10 0/90/0/90 double x-ply ballistic sheets containing a polypropylene resin; 10-15 0/90/0/90 double x-ply ballistic sheets containing a polyethylene resin and 10-15 0/90/0/90 double x-ply ballistic sheets containing a polypropylene resin; 15-20 0/90/0/90 double x-ply ballistic sheets containing a polyethylene resin and 15-20 0/90/0/90 double x-ply ballistic sheets containing a polypropylene resin.

Examples of suitable stacks of double x-ply ballistic sheets 1005 for a ballistic resistant panel 100 can include a first plurality of THERMOBALLISTIC ballistic sheets 1025 arranged in a stack having a top surface and a bottom surface and bounded on the top surface by a first plurality of K-FLEX ballistic sheets 1020 and bounded on the bottom surface by a second plurality of K-FLEX ballistic sheets 1030, as shown in FIG. 11. Examples include: 1-5 K-FLEX 0/90/0/90 double x-ply ballistic sheets, 1-5 THERMOBALLISTIC 0/90/0/90 double x-ply ballistic sheets, 1-5 K-FLEX 0/90/0/90 double x-ply ballistic sheets; 2-5 K-FLEX 0/90/0/90 double x-ply ballistic sheets, 2-5 THERMOBALLISTIC 0/90/0/90 double x-ply ballistic sheets, 2-5 K-FLEX 0/90/0/90 double x-ply ballistic sheets; 3-5 K-FLEX 0/90/0/90 double x-ply ballistic sheets, 3-5 THERMOBALLISTIC 0/90/0/90 double x-ply ballistic sheets, 3-5 K-FLEX 0/90/0/90 double x-ply ballistic sheets; 4 K-FLEX 0/90/0/90 double x-ply ballistic sheets, 5 THERMOBALLISTIC 0/900/90 double x-ply ballistic sheets, 4 K-FLEX 0/900/90 double x-ply ballistic sheets; 3 K-FLEX 0/90/0/90 double x-ply ballistic sheets, 4 THERMOBALLISTIC 0/90/0/90 double x-ply ballistic sheets, 3 K-FLEX 0/90/0/90 double x-ply ballistic sheets; 3 K-FLEX 0/90/0/90 double x-ply ballistic sheets, 4 THERMOBALLISTIC 0/90/0/90 double x-ply ballistic sheets, 3 K-FLEX 0/90/0/90 double x-ply ballistic sheets; 2 K-FLEX 0/90/0/90 double x-ply ballistic sheets, 4 THERMOBALLISTIC 0/90/0/90 double x-ply ballistic sheets, 2 K-FLEX 0/90/0/90 double x-ply ballistic sheets; 5-15 K-FLEX 0/90/0/90 double x-ply ballistic sheets, 5-15 THERMOBALLISTIC 0/90/0/90 double x-ply ballistic sheets, 5-15 K-FLEX 0/90/0/90 double x-ply ballistic sheets; or 15-20 K-FLEX 0/90/0/90 double x-ply ballistic sheets, 15-20 THERMOBALLISTIC 0/90/0/90 double x-ply ballistic sheets, 15-20 K-FLEX 0/90/0/90 double x-ply ballistic sheets.

Examples of suitable stacks of double x-ply ballistic sheets 1005 for a flexible ballistic resistant panel 100 can include a first plurality of K-FLEX ballistic sheets 1025 arranged in a stack having a top surface and a bottom surface and bounded on the top surface by a first plurality of THERMOBALLISTIC ballistic sheets 1020 and bounded on the bottom surface by a second plurality of THERMOBALLISTIC ballistic sheets 1030, as shown in FIG. 12. Examples include: 1-5 THERMOBALLISTIC 0/90/0/90 double x-ply ballistic sheets, 1-5 K-FLEX 0/90/0/90 double x-ply ballistic sheets, 1-5 THERMOBALLISTIC 0/90/0/90 double x-ply ballistic sheets; 2-5 THERMOBALLISTIC 0/90/0/90 double x-ply ballistic sheets, 2-5 K-FLEX 0/90/0/90 double x-ply ballistic sheets, 2-5 THERMOBALLISTIC 0/90/0/90 double x-ply ballistic sheets; 3-5 THERMOBALLISTIC 0/90/0/90 double x-ply ballistic sheets, 3-5 K-FLEX 0/90/0/90 double x-ply ballistic sheets, 3-5 THERMOBALLISTIC 0/90/0/90 double x-ply ballistic sheets; 4 THERMOBALLISTIC 0/90/0/90 double x-ply ballistic sheets, 5 K-FLEX 0/900/90 double x-ply ballistic sheets, 4 THERMOBALLISTIC 0/900/90 double x-ply ballistic sheets; 3 THERMOBALLISTIC 0/90/0/90 double x-ply ballistic sheets, 4 K-FLEX 0/90/0/90 double x-ply ballistic sheets, 3 THERMOBALLISTIC 0/90/0/90 double x-ply ballistic sheets; 3 THERMOBALLISTIC 0/90/0/90 double x-ply ballistic sheets, 4 K-FLEX 0/90/0/90 double x-ply ballistic sheets, 3 THERMOBALLISTIC 0/90/0/90 double x-ply ballistic sheets; 2 THERMOBALLISTIC 0/90/0/90 double x-ply ballistic sheets, 4 K-FLEX 0/90/0/90 double x-ply ballistic sheets, 2 THERMOBALLISTIC 0/90/0/90 double x-ply ballistic sheets; 5-15 THERMOBALLISTIC 0/90/0/90 double x-ply ballistic sheets, 5-15 K-FLEX 0/90/0/90 double x-ply ballistic sheets, 5-15 THERMOBALLISTIC 0/90/0/90 double x-ply ballistic sheets; or 15-20 THERMOBALLISTIC 0/90/0/90 double x-ply ballistic sheets, 15-20 K-FLEX 0/90/0/90 double x-ply ballistic sheets, 15-20 THERMOBALLISTIC 0/90/0/90 double x-ply ballistic sheets.

Examples of suitable stacks of double x-ply ballistic sheets 1005 for a flexible ballistic resistant panel 100 can include a grouping of 1-10, 4-10, 6-10, 10-15, or 15-20 double x-ply ballistic sheets made of fibers such as, for example, aramid or UHMWPE fibers. Examples of suitable stacks of double x-ply ballistic sheets 1005 for a ballistic panel 100 can include a grouping of 1-10, 4-10, 6-10, 10-15, or 15-20 THERMOBALLISTIC 0/90/0/90 double x-ply ballistic sheets. Other examples of suitable stacks of double x-ply ballistic sheets 1005 for a ballistic panel 100 can include a grouping of 1-10, 4-10, 6-10, 10-15, or 15-20 K-FLEX 0/90/0/90 double x-ply ballistic sheets.

Panels Constructed from Uni-Ply, X-Ply, or Double X-Ply Ballistic Sheets

Although specific examples of stacks made exclusively of uni-ply, x-ply, or double x-ply ballistic sheets are provided herein, these examples are not limiting. Suitable stacks can include any combination of uni-ply, x-ply, double-x ply, triple x-ply, or other more elaborate multilayered ballistic sheets. In any of the examples provided herein, two uni-ply ballistic sheets can be substituted for an x-ply ballistic sheet, an x-ply ballistic sheet can be substituted for two uni-ply ballistic sheets, four uni-ply ballistic sheets can be substituted for a double x-ply ballistic sheet, a double x-ply ballistic sheet can be substituted for four uni-ply ballistic sheets, two x-ply ballistic sheets can be substituted for a double x-ply ballistic sheets, and a double x-ply ballistic sheet can be substituted for two x-ply ballistic sheets.

Panels Constructed from Ballistic Sheets and Fiberglass Sheets

One or more fiberglass sheets (e.g. sheets made of woven glass fibers or sheets made of glass fibers arranged unidirectionally into uni-ply or x-ply), can be incorporated into any of the various stacks of ballistic sheets described herein to form a ballistic resistant panel (see, e.g. FIG. 13). Fiberglass sheets have several attributes that make them desirable for inclusion in a ballistic resistant panel. Specifically, fiberglass sheets are less expensive than sheets made of aramid fibers, which translates to lower cost panels. Also, fiberglass sheets can enhance stab resistance of the panel 100. The fiberglass sheets can have any suitable thickness depending on the application of the panel. For example, for applications that require flexible panels, the thickness of each fiberglass sheet can be about 0.006, 0.009, 0.010, 0.005-0.020, 0.010-0.020, or 0.020-0.030 inches.

Examples of suitable stacks of ballistic sheets for a ballistic resistant panel can include a plurality of x-ply ballistic sheets containing aramid fibers and a first resin with a first melting temperature and a plurality of fiberglass sheets containing glass fibers (see, e.g. FIG. 13). Examples include: 1-10 x-ply ballistic sheets containing aramid fibers and resin and 1-10 fiberglass sheets; 4-10 x-ply ballistic sheets containing aramid fibers and resin and 4-10 fiberglass sheets; 6-10 x-ply ballistic sheets containing aramid fibers and resin and 6-10 fiberglass sheets; 10-15 x-ply ballistic sheets containing aramid fibers and resin and 10-15 fiberglass sheets; 15-20 x-ply ballistic sheets containing aramid fibers and resin and 15-20 fiberglass sheets.

Examples of suitable stacks of ballistic sheets for a ballistic resistant panel 100 can include a first plurality of x-ply ballistic sheets containing a polyethylene resin with a melting temperature of about 215-240 degrees F. and a plurality of s-glass sheets (see, e.g. FIG. 13). Suitable examples include: 1-10 0/90 x-ply ballistic sheets containing a polyethylene resin and 1-10 s-glass fiberglass sheets; 4-10 0/90 x-ply ballistic sheets containing a polyethylene resin and 4-10 s-glass fiberglass sheets; 6-10 0/90 x-ply ballistic sheets containing a polyethylene resin and 6-10 s-glass fiberglass sheets; 10-20 0/90 x-ply ballistic sheets containing a polyethylene resin and 10-20 s-glass fiberglass sheets; 20-30 0/90 x-ply ballistic sheets containing a polyethylene resin and 20-30 s-glass fiberglass sheets.

Examples of suitable stacks of ballistic sheets 1005 for a ballistic resistant panel 100 can include a first plurality of s-glass fiberglass sheets 1025 arranged in a stack having a top surface and a bottom surface and bounded on the top surface by a first plurality of K-FLEX ballistic sheets 1020 and bounded on the bottom surface by a second plurality of K-FLEX ballistic sheets 1030. as shown in FIG. 13. Examples include: 1-10 K-FLEX 0/90 x-ply ballistic sheets, 1-10 s-glass fiberglass sheets, 1-10 K-FLEX 0/90 x-ply ballistic sheets; 4-10 K-FLEX 0/90 x-ply ballistic sheets, 4-10 s-glass fiberglass sheets, 4-10 K-FLEX 0/90 x-ply ballistic sheets; 6-10 K-FLEX 0/90 x-ply ballistic sheets, 6-10 s-glass fiberglass sheets, 6-10 K-FLEX 0/90 x-ply ballistic sheets; 8 K-FLEX 0/90 x-ply ballistic sheets, 10 s-glass fiberglass sheets, 8 K-FLEX 0/90 x-ply ballistic sheets; 8 K-FLEX 0/90 x-ply ballistic sheets, 5-7 s-glass fiberglass sheets, 8 K-FLEX 0/90 x-ply ballistic sheets; 6 K-FLEX 0/90 x-ply ballistic sheets, 8 s-glass fiberglass sheets, 6 K-FLEX 0/90 x-ply ballistic sheets; 5 K-FLEX 0/90 x-ply ballistic sheets, 8 s-glass fiberglass sheets, 5 K-FLEX 0/90 x-ply ballistic sheets; 4 K-FLEX 0/90 x-ply ballistic sheets, 8 s-glass fiberglass sheets, 4 K-FLEX 0/90 x-ply ballistic sheets; 6 K-FLEX 0/90 x-ply ballistic sheets, 6 s-glass fiberglass sheets, 6 K-FLEX 0/90 x-ply ballistic sheets; 5 K-FLEX 0/90 x-ply ballistic sheets, 5 s-glass fiberglass sheets, 5 K-FLEX 0/90 x-ply ballistic sheets; or 2 or more K-FLEX 0/90 x-ply ballistic sheets, 1 or more s-glass fiberglass sheets, 2 or more K-FLEX 0/90 x-ply ballistic sheets.

Suitable stacks can include one or more uni-ply ballistic sheets and one or more fiberglass sheets. Examples include: 1-20 K-FLEX uni-ply ballistic sheets, 1-10 s-glass fiberglass sheets, 1-20 K-FLEX uni-ply ballistic sheets; 8-20 K-FLEX uni-ply ballistic sheets, 4-10 s-glass fiberglass sheets, 8-20 K-FLEX uni-ply ballistic sheets; 12-20 K-FLEX uni-ply ballistic sheets, 6-10 s-glass fiberglass sheets, 12-20 K-FLEX uni-ply ballistic sheets; 16 K-FLEX uni-ply ballistic sheets, 10 s-glass fiberglass sheets, 16 K-FLEX uni-ply ballistic sheets; 16 K-FLEX uni-ply ballistic sheets, 5-7 s-glass fiberglass sheets, 16 K-FLEX uni-ply ballistic sheets; 12 K-FLEX uni-ply ballistic sheets, 8 s-glass fiberglass sheets, 12 K-FLEX uni-ply ballistic sheets; 10 K-FLEX uni-ply ballistic sheets, 8 s-glass fiberglass sheets, 10 K-FLEX uni-ply ballistic sheets; 8 K-FLEX uni-ply ballistic sheets, 8 s-glass fiberglass sheets, 8 K-FLEX uni-ply ballistic sheets; 12 K-FLEX uni-ply ballistic sheets, 6 s-glass fiberglass sheets, 12 K-FLEX 0/90 x-ply ballistic sheets; or 10 K-FLEX uni-ply ballistic sheets, 5 s-glass fiberglass sheets, 10 K-FLEX uni-ply ballistic sheets; or 2 or more K-FLEX uni-ply ballistic sheets, 1 or more s-glass fiberglass sheets, 2 or more K-FLEX uni-ply ballistic sheets.

Suitable stacks can include one or more double x-ply ballistic sheets and one or more fiberglass sheets. Examples include: 1-10 K-FLEX 0/90/0/90 double x-ply ballistic sheets, 1-10 s-glass fiberglass sheets, 1-10 K-FLEX 0/90/0/90 double x-ply ballistic sheets; 2-5 K-FLEX 0/90/0/90 double x-ply ballistic sheets, 4-10 s-glass fiberglass sheets, 2-5 K-FLEX 0/90/0/90 double x-ply ballistic sheets; 6-10 K-FLEX 0/90/0/90 double x-ply ballistic sheets, 6-10 s-glass fiberglass sheets, 3-5 K-FLEX 0/90/0/90 double x-ply ballistic sheets; 4 K-FLEX 0/90/0/90 double x-ply ballistic sheets, 10 s-glass fiberglass sheets, 4 K-FLEX 0/90/0/90 double x-ply ballistic sheets; 4 K-FLEX 0/90/0/90 double x-ply ballistic sheets, 5-7 s-glass fiberglass sheets, 4 K-FLEX 0/90/0/90 double x-ply ballistic sheets; 3 K-FLEX 0/90/0/90 double x-ply ballistic sheets, 4-8 s-glass fiberglass sheets, 3 K-FLEX 0/90/0/90 double x-ply ballistic sheets; 2 K-FLEX 0/90/0/90 double x-ply ballistic sheets, 4-8 s-glass fiberglass sheets, 2 K-FLEX 0/90/0/90 double x-ply ballistic sheets; 4 K-FLEX 0/90/0/90 double x-ply ballistic sheets, 8 s-glass fiberglass sheets, 4 K-FLEX 0/90/0/90 double x-ply ballistic sheets; 3 K-FLEX 0/90/0/90 double x-ply ballistic sheets, 6 s-glass fiberglass sheets, 3 K-FLEX 0/90/0/90 double x-ply ballistic sheets; 3 K-FLEX 0/90/0/90 double x-ply ballistic sheets, 5 s-glass fiberglass sheets, 3 K-FLEX 0/90/0/90 double x-ply ballistic sheets; or 2 or more K-FLEX 0/90/0/90 double x-ply ballistic sheets, 1 or more s-glass fiberglass sheets, 2 or more K-FLEX 0/90/0/90 double x-ply ballistic sheets.

### Methods for Manufacturing Flexible Ballistic Resistant Panels

A method of manufacturing a ballistic resistant panel 100 can include providing a stack of ballistic sheets 1005, inserting the stack of ballistic sheets into a vacuum bag 1310, evacuating air from the vacuum bag, and heating the stack of ballistic sheets in the vacuum bag to a predetermined temperature for a predetermined duration. In some examples, the predetermined temperature can be about 250-550, 225-550, 225-350, 250-300, 250-275, 265-275, 225-250, or 200-240 degrees F., and the predetermined duration can be about 1, 5, 15-30, 30-60, 45-60, 60-120, 120-240, or 240-480 minutes. The method can include applying a predetermined pressure to the stack of ballistic sheets in the vacuum bag for a second predetermined duration. The predetermined pressure can be about 10-100, 50-75, 75-100, 100-500, 500-1,000, 1,000-2,500, 2,500-15,000, or 15,000-30,000 psi, and the second predetermined duration can be about 1, 5, 15-30, 30-60, 45-60, 60-120, 120-240, or 240-480 minutes. The step of heating the stack of ballistic sheets in the vacuum bag to the predetermined temperature for the predetermined duration can occur concurrently with applying the predetermined pressure to the stack of ballistic sheets in the vacuum bag 1310 for the second predetermined duration. The method can include encasing the stack of ballistic sheets 1005 in a waterproof cover 1105 prior to inserting the stack of ballistic sheets into the vacuum bag 1310. The waterproof cover 1105 can be made of nylon coated with polyurethane, polypropylene, polyethylene, or polyvinylchloride.

With respect to the method described above, the stack of ballistic sheets 1005 can include a first plurality of ballistic sheets 1020 having a first resin with a melting temperature of about 215-240, 240-265, 265-295, or 295-340 degrees F. The stack 1005 can also include a second plurality of ballistic sheets 1025 adjacent to the first plurality of ballistic sheets, where the second plurality of ballistic sheets have a second resin with a melting temperature of about 255-295, 295-330, 330-355, or 355-375 degrees F. The stack 1005 can also include a third plurality of ballistic sheets 1030 adjacent to the second plurality of ballistic sheets, where the third plurality of ballistic sheets have a third resin with a melting temperature of about 215-240, 240-265, 265-295, or 295-340 degrees F. The first plurality of ballistic sheets 1020 can include 1-10, 10-20, or 20-30 x-ply ballistic sheets, where the ballistic sheets are made of aramid fibers and the first resin is made of polyethylene. The second plurality of ballistic sheets 1025 can include 1-10, 10-20, or 20-30 x-ply ballistic sheets, where the ballistic sheets are made of aramid fibers and the second resin is made of polypropylene. Similar to the first plurality of ballistic sheets 1020, the third plurality of ballistic sheets 1030 can include 1-10, 10-20, or 20-30 x-ply ballistic sheets, where the ballistic sheets are made of aramid fibers and the third resin is made of polyethylene.

Following the heating and pressure steps described above, the method can also include a step of cooling the stack of ballistic sheets 1005 in the vacuum bag 1310 from the predetermined temperature to room temperature. Cooling can occur using any suitable heat transfer method, such as natural convection, forced convection, or conduction (e.g. by submerging the waterproof panels 100 in a cooling bath).

In some methods of manufacturing flexible ballistic resistant panels 100, a stack of ballistic sheets 1005 can be provided where the stack has a first plurality of ballistic sheets 1020, a second plurality of ballistic sheets 1025 adjacent to the first plurality of ballistic sheets, and a third plurality of ballistic sheets 1030 adjacent to the second plurality of ballistic sheets. Each of the first plurality of ballistic sheets 1020 can be formed of a first arrangement of aramid fibers, where the first arrangement of aramid fibers defines a two-dimensional pattern. The first plurality of ballistic sheets 1020 can be stacked according to the two-dimensional pattern. Each of the second plurality of ballistic sheets 1025 can be formed of a second arrangement of aramid fibers, where the second arrangement of aramid fibers substantially conforms to the two-dimensional pattern. The second plurality of ballistic sheets 1025 can be stacked according to the two-dimensional pattern. Each of the third plurality of ballistic sheets 1030 can be formed of a third arrangement of aramid fibers, where the third arrangement of aramid fibers substantially conforms to the two-dimensional pattern. The third plurality of ballistic sheets 1030 can be stacked according to the two-dimensional pattern. The first plurality of ballistic sheets 1020, the second plurality of ballistic sheets 1025, and the third plurality of ballistic sheets 1030 can be formed in a stack 1005 according to the two-dimensional pattern. The method can include inserting the stack of ballistic sheets 1005 into a vacuum bag 1310 and evacuating air from the vacuum bag. The method can include heating the stack of ballistic sheets 1005 to a predetermined temperature for a predetermined duration. The predetermined temperature can be between about 200 and 500 degrees F. and, more specifically, about 250-300, 265-275, 225-250, or 200-240 degrees F. The predetermined duration can be at least 5 minutes and, more specifically, about 30-45, 45-60, or 60-120 minutes. The method can include applying a predetermined pressure to the stack of ballistic sheets 1005 in the vacuum bag 1310 for a second predetermined duration. The predetermined pressure can be at least 10 psi, and the second predetermined duration is at least 5 minutes. More specifically, the predetermined pressure can be about 10-100, 50-75, or 75-100 psi, and the second predetermined duration can be about 30-45, 45-60, 60-120, 120-240, 240-480 minutes.

In the method described above, applying the predetermined pressure to the stack of ballistic sheets 1005 in the vacuum bag 1310 for the second predetermined duration can occur concurrently with heating the stack of ballistic sheets in the vacuum bag to the predetermined temperature for the predetermined duration. The method can include encasing the stack of ballistic sheets 1005 in a waterproof cover 1105, as shown in FIG. 7, prior to inserting the stack of ballistic sheets into the vacuum bag 1310. The waterproof cover can be made of nylon coated with polyurethane, polyvinylchloride, polypropylene, or polyethylene.

In the method described above, the first plurality of ballistic sheets 1020 can include a first resin with a melting temperature of about 215-240 degrees F., the second plurality of ballistic sheets 1025 can include a second resin with a melting temperature of about 255-295 degrees F., and the third plurality of ballistic sheets 1030 can include a third resin with a melting temperature of about 215-240 degrees F. To promote partial or full bonding of the ballistic sheets within the first and third pluralities of ballistic sheets (and to avoid bonding of the ballistic sheets within second plurality of ballistic sheets 1025), the predetermined temperature can be about 200-240 or 225-250 degrees F., which is below the melting temperature of the second resin.

In another example, the first plurality of ballistic sheets 1020 can include a first resin with a melting temperature of about 215-240 degrees F., the second plurality of ballistic sheets 1025 can include a second resin with a melting temperature of about 295-330 degrees F., and the third plurality of ballistic sheets 1030 can include a third resin with a melting temperature of about 215-240 degrees F. To promote partial or full bonding of the ballistic sheets within the first and third pluralities of ballistic sheets (and to avoid bonding of the ballistic sheets within second plurality of ballistic sheets 1025), the predetermined temperature can be about 200-240, 225-250, or 265-275 degrees F., which is below the melting temperature of the second resin. In this example, the first plurality of ballistic sheets 1020 can include 1-10 K-FLEX 0/90 x-ply ballistic sheets, the second plurality of ballistic sheets 1025 can include 1-10 THERMOBALLISTIC 0/90 x-ply ballistic sheets, and the third plurality of ballistic sheets 1030 can include 1-10 K-FLEX 0/90 x-ply ballistic sheets.

The method described above can further include cooling the stack of ballistic sheets 1005 in the vacuum bag from the predetermined temperature to room temperature. The method can also include subjecting the panel 100 to a break-in process to enhance its flexibility.

### Flexible Ballistic Panel Having a Plurality of Ballistic Sheets

In one example, as shown in FIG. 10, a flexible ballistic resistant panel can include a plurality of ballistic sheets (i.e. a stack of ballistic sheets 1005). Each of the plurality of ballistic sheets 1005 can be formed of an arrangement of higher performance fibers (e.g. aramid fibers), and the arrangement of high performance fibers can define a two-dimensional pattern. The plurality of ballistic sheets can be stacked according to the two-dimensional pattern, where each of the plurality of ballistic sheets is at least partially bonded to at least one adjacent ballistic sheet in the plurality of ballistic sheets. In some examples, the plurality of ballistic sheets 1005 can include 1-10, 10-20, or 20-30 ballistic sheets. The plurality of ballistic sheets 1005 can be made of a plurality of high performance fibers coated with a thermoplastic polymer resin. The thermoplastic polymer resin can have a melting temperature of about 215-240, 240-265, 265-295, 295-340, 340-355, or 355-375 degrees F.

In another example, as shown in FIG. 10, a flexible ballistic resistant panel 100 can include a plurality of ballistic sheets 1005. Each of the plurality of ballistic sheets can be formed of an arrangement of high performance fibers, such as thermoplastic polyethylene fibers (e.g. UHMWPE fibers), and the arrangement of thermoplastic polyethylene fibers can define a two-dimensional pattern. The plurality of ballistic sheets 1005 can be stacked according to the two-dimensional pattern, where each of the plurality of ballistic sheets is at least partially bonded to at least one adjacent ballistic sheet in the plurality of ballistic sheets. In some examples, the plurality of ballistic sheets can include 1-10, 10-20, or 20-30 ballistic sheets made of thermoplastic polyethylene fabric, such as TENSYLON.

The plurality of ballistic sheets 1005, whether containing aramid fibers, thermoplastic polyethylene fibers, or both, can be encased by a waterproof cover 1105, as shown in FIG. 10. The waterproof cover 1105 can be made of any suitable material, such as rubber, NYLON, RAYON, ripstop NYLON, CORDURA, polyvinyl chloride, polyurethane, silicone elastomer, or fluoropolymer. The waterproof cover 1105 can be adhered to an outer surface of the plurality of ballistic sheets 1005 to prevent movement of the plurality of ballistic sheets relative to the waterproof cover. The flexible ballistic resistant panel 100 can include a coating on the inner surface of the waterproof cover. The coating can improve water resistance and can serve as an adhesive layer. The coating can be made of polyurethane, polyvinylchloride, polyethylene, or polypropylene.

### Flexible Ballistic Panel Having First and Second Pluralities of Ballistic Sheets

A flexible ballistic resistant panel 100 can include a first plurality of ballistic sheets 1020 made of aramid fibers and coated with a first resin having a first melting temperature. The flexible ballistic resistant panel can also include a second plurality of ballistic sheets 1025 adjacent to the first plurality of ballistic sheets, where the second plurality of ballistic sheets are made of aramid fibers coated with a second resin having a second melting temperature. The second melting temperature can be greater than the first melting temperature. The first resin can be a thermoplastic polymer with a melting temperature of about 215-240 degrees F. The second resin can be a thermoplastic polymer with a melting temperature of about 255-295 or 295-330 degrees F. In some examples, the first resin can be polyethylene, and the second resin can be polypropylene. The first plurality of ballistic sheets 1020 can include about 1-10, 10-20, or 20-30 ballistic sheets. Similarly, the second plurality of ballistic sheets 1025 can include about 1-10, 10-20, or 20-30 ballistic sheets. In certain examples, the first plurality of ballistic sheets 1020 can include 1-10, 10-20, or 20-30 K-FLEX 0/90 x-ply ballistic sheets, and the second plurality of ballistic sheets 1025 can include 1-10, 10-20, or 20-30 THERMOBALLISTIC 0/90 x-ply ballistic sheets. In some examples, the first plurality of ballistic sheets 1020 can include 5-10 K-FLEX 0/90 x-ply ballistic sheets, and the second plurality of ballistic sheets 1025 can include 5-10 THERMOBALLISTIC 0/90 x-ply ballistic sheets. The flexible ballistic resistant panel 100 can include a waterproof cover 1105 encasing the first and second pluralities of ballistic sheets (1020, 1025). The waterproof cover 1105 can be made of any suitable material, such as nylon coated with polyurethane, polypropylene, polyvinylchloride, or polyethylene.

### Flexible Ballistic Panel Having First, Second, and Third Pluralities of Ballistic Sheets

A flexible ballistic resistant panel 100 can include a first plurality of ballistic sheets 1020, each of the first plurality of ballistic sheets 1020 being formed of a first arrangement of aramid fibers. The first arrangement of aramid fibers can define a two-dimensional pattern, and the first plurality of ballistic sheets 1020 can be stacked according to the two-dimensional pattern. The flexible ballistic resistant panel 100 can include a second plurality of ballistic sheets 1025 adjacent to the first plurality of ballistic sheets. Each of the second plurality of ballistic sheets 1025 can be formed of a second arrangement of aramid fibers. The second arrangement of aramid fibers can substantially conform to the two-dimensional pattern, and the second plurality of ballistic sheets can be stacked according to the two-dimensional pattern. The flexible ballistic resistant panel 100 can include a third plurality of ballistic sheets 1030 adjacent to the second plurality of ballistic sheets. Each of the third plurality of ballistic sheets 1030 can be formed of a third arrangement of aramid fibers. The third arrangement of aramid fibers can substantially conform to the two-dimensional pattern, and the third plurality of ballistic sheets 1030 can be stacked according to the two-dimensional pattern. The first plurality of ballistic sheets 1020, the second plurality of ballistic sheets 1025, and the third plurality of ballistic sheets 1030 can be formed in a stack 1005 according to the two-dimensional pattern. The flexible ballistic resistant panel 100 can include a waterproof cover 1105 encasing the first plurality of ballistic sheets 1020, the second plurality of ballistic sheets 1025, and the third plurality of ballistic sheets 1030. Within the panel 100, each of the first plurality of ballistic sheets 1020 can be at least partially bonded to at least one adjacent ballistic sheet in the first plurality of ballistic sheets. Likewise, each of the third plurality of ballistic sheets 1030 can be at least partially bonded to at least one adjacent ballistic sheet in the third plurality of ballistic sheets.

The first plurality of ballistic sheets 1020 can include 1-10, 10-20, or 20-30 ballistic sheets, the second plurality of ballistic sheets 1025 can include 1-10, 10-20, or 20-30 ballistic sheets, and the third plurality of ballistic sheets 1030 can include 1-10, 10-20, or 20-30 ballistic sheets. In some examples, where the flexible ballistic resistant panel 100 is configured to be certified as Type IIIA flexible armor under NIJ Standard-0101.06, the first plurality of ballistic sheets 1020 can include 5-10 or 6-8 ballistic sheets, the second plurality of ballistic sheets 1025 can include 5-10 or 6-8 ballistic sheets, and the third plurality of ballistic sheets 1030 can include 5-10 or 6-8 ballistic sheets. In some examples, the first plurality of ballistic sheets 1020 can be K-FLEX 0/90 x-ply ballistic sheets, the second plurality of ballistic sheets 1025 can be THERMOBALLISTIC 0/90 x-ply ballistic sheets, and the third plurality of ballistic sheets 1030 can be K-FLEX 0/90 x-ply ballistic sheets. The panel 100 can have a thickness of less than 0.5, 0.375, or 0.25 inches, and where the panel is configured to be certified as Type IIIA flexible armor under NIJ Standard-0101.06, can have a thickness of 0.15-0.22 or about 0.215 inches.

The first plurality of ballistic sheets 1020 can include a first resin made of polyethylene and having a melting temperature of about 215-240, 240-265, 265-295, or 295-340 degrees F. The second plurality of ballistic sheets 1025 can include a second resin made of polypropylene and having a melting temperature of about 255-295, 295-330, 330-355, or 355-375 degrees F. The third plurality of ballistic sheets 1030 can include a third resin made of polyethylene and having a melting temperature of about 215-240, 240-265, 265-295, or 295-340 degrees F.

In some examples, the flexible ballistic resistant panel 100 can include a first plurality of ballistic sheets 1020 made of high performance fibers, such as aramid fibers. Each ballistic sheet within the first plurality of ballistic sheets 1020 can be at least partially bonded to at least one adjacent ballistic sheet in the first plurality of ballistic sheets. The panel 100 can include a second plurality of ballistic sheets 1025 made of high performance fibers, such as aramid fibers. The second plurality of ballistic sheets 1025 can be positioned adjacent to the first plurality of ballistic sheets 1020. The panel 100 can include a third plurality of ballistic sheets 1030 made of high performance fibers, such as aramid fibers. The third plurality of ballistic sheets 1030 can be positioned adjacent to the second plurality of ballistic sheets 1025. Each ballistic sheet within the third plurality of ballistic sheets 1030 can be at least partially bonded to at least one adjacent ballistic sheet in the third plurality of ballistic sheets. The first plurality of ballistic sheets 1020 can include 1-10, 10-20, or 20-30 ballistic sheets, the second plurality of ballistic sheets 1025 can include 1-10, 10-20, or 20-30 ballistic sheets, and the third plurality of ballistic sheets 1030 can include 1-10, 10-20, or 20-30 ballistic sheets. In certain examples, first plurality of ballistic sheets 1020 can include 1-10 K-FLEX 0/90 x-ply ballistic sheets, the second plurality of ballistic sheets 1025 can include 1-10 THERMOBALLISTIC 0/90 x-ply ballistic sheets or s-glass fiberglass sheets, and the third plurality of ballistic sheets 1030 can include 1-10 K-FLEX 0/90 x-ply ballistic sheets. The panel 100 can include a waterproof cover encasing a stack of ballistic sheets 1005 consisting of the first plurality of ballistic sheets 1020, the second plurality of ballistic sheets 1025, and the third plurality of ballistic sheets 1030. In some examples, the waterproof cover 1105 can be made of nylon coated with polyurethane, polypropylene, polyethylene, or polyvinylchloride. A first resin in the first plurality of ballistic sheets 1020 can have a melting temperature of about 215-240, 240-265, 265-295, or 295-340 degrees F. A second resin in the second plurality of ballistic sheets 1025 can have a melting temperature of about 255-295, 295-330, 330-355, or 355-375 degrees F. A third resin in the third plurality of ballistic sheets can have a melting temperature of about 215-240, 240-265, 265-295, or 295-340 degrees F.

### Stitching

The flexible ballistic resistant panels 100 described herein do not require stitching to be as effective, or more effective, than existing panels with similar dimensions. However, where added labor costs are not a primary concern, the panels described herein can include stitches, such as quilt stitches, radial stitches, row stitches, box stitches, or a combination thereof. Stitches can be added to the stack of ballistic sheets at any stage in the manufacturing process, including before vacuum bagging, after vacuum bagging, before heating, after heating, before applying pressure, after applying pressure, etc. Stitches may be desirable to defend against certain types of ballistic threats.

### Reversible Panel

Many ballistic resistant panels are designed to have a strike face (see, e.g. the ceramic plate 32 in FIG. 5) and a wear face. A strike face is a surface that is designed to face an incoming ballistic threat, and a wear face is a surface that is designed to face the wearer's torso. Panels with a strike face are directional and must be oriented with the strike face facing toward an incoming projectile. If the panel is improperly oriented and a projectile strikes the wear face, the panel will likely fail to perform at the panel's certification level. For example, if a soldier inserts a ballistic resistant panel into a carrier vest, but accidentally orients the panel with the wear face directed outward, the panel may fail to perform according to its certification level when struck by a projectile, and the projectile may pass through the panel.

To ensure consistent performance of the ballistic resistant panel regardless of its orientation, it can be desirable to create a panel 100 that does not have a wear face. Instead, the panel 100 can be symmetrical or nearly symmetrical from a front surface to a back surface (e.g. the panel can have a symmetrical arrangement of ballistic sheets), thereby permitting either side of the panel to serve as a strike face without altering performance. In other instances, it may be suitable to have a non-symmetrical panel. For example, a non-symmetrical panel may be suitable where the panel will be permanently or semi-permanently installed (e.g. in a vehicle door or around an oil or gas pipeline), since the panel will not be moved often and, therefore, the risk of user installation error is greatly diminished or eliminated entirely.

### Multiple Stacks of Ballistic Sheets

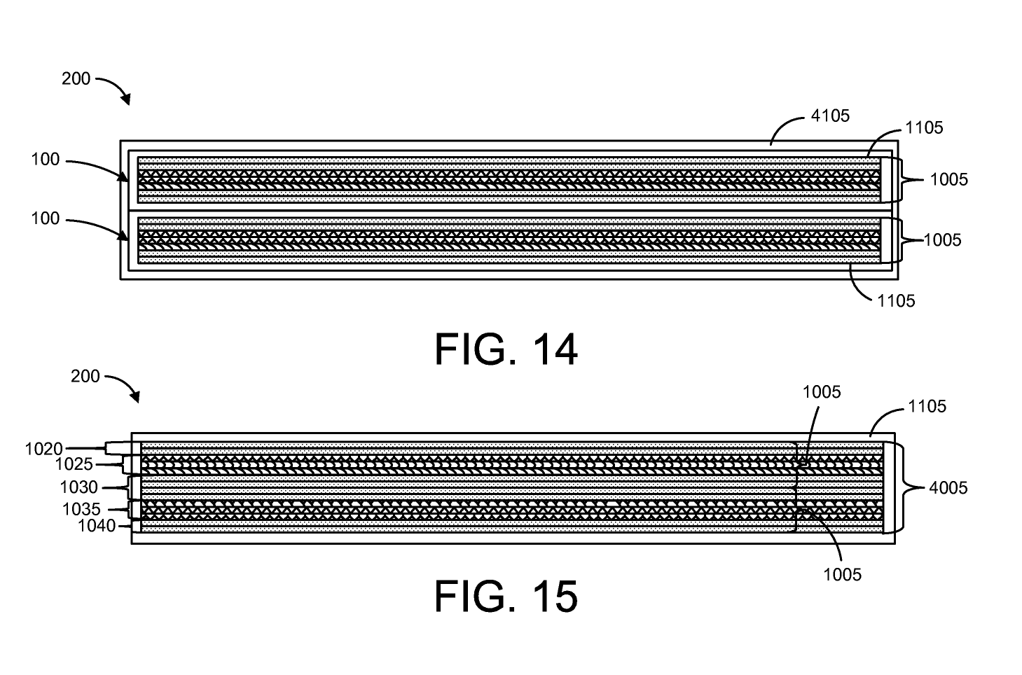

Two or more stacks of ballistic sheets 1005 can be combined to provide additional protection against ballistic threats. For example, two or more stacks of ballistic sheets 1005 can be combined to form a stack of panels 200, as shown in FIGS. 14-16. In one example shown in FIG. 15, two stacks of ballistic sheets 1005 can be combined within a single waterproof cover 1105 to form a combined stack of ballistic sheets 4005. The combined stack 4005 can include a first plurality of ballistic sheets 1020, a second plurality of ballistic sheets 1025, a third plurality of ballistic sheets 1030, a fourth plurality of ballistic sheets 1035, and a fifth plurality of ballistic sheets 1040. This configuration can be desirable in situations where ballistic performance is more important than flexibility, since flexibility will decrease as the number of ballistic sheets in the stack increases. In this example, the third plurality 1030 may in fact be two pluralities of the same type of ballistic sheets that are shown as a single plurality of ballistic sheets after the two separate stacks are arranged into a combined stack.

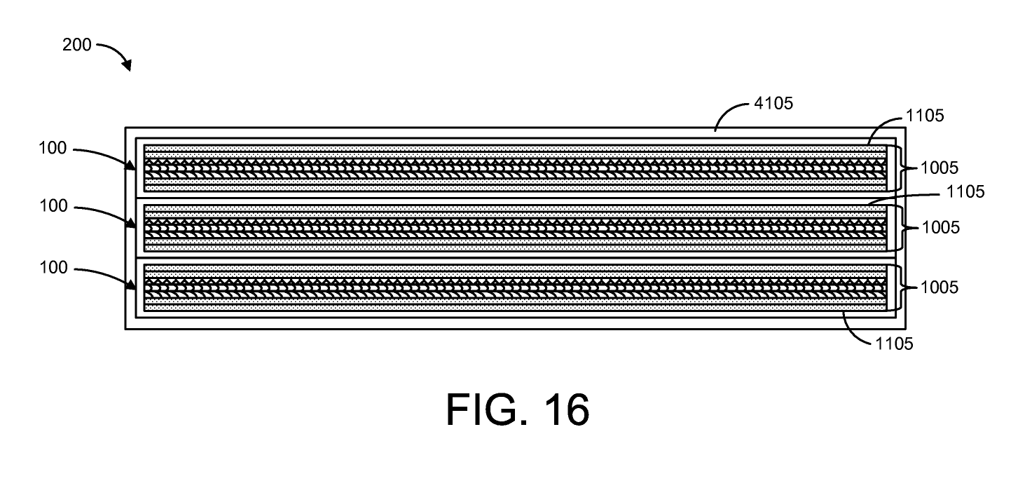

In some examples, the stack of panels 200 can include two or more flexible panels 100. FIG. 14 shows a stack of panels 200 containing two flexible ballistic resistant panels 100. FIG. 16 shows a stack of panels 200 containing three flexible ballistic resistant panels 100. Each flexible panel 100 can include its own waterproof cover 1105, and the stack of panels 200 can include an additional waterproof cover 4105 to provide even greater protection against water intrusion. For example, if the additional waterproof cover 4105 is torn during use, the individual waterproof covers 1105 will protect each stack of ballistic sheets 1005 within each flexible panel 100 from water intrusion.

### Modular Armor Systems

A modular armor system can include a carrier vest 30, similar to the vest shown in FIG. 5, configured to receive one or more flexible ballistic resistant panels 100 as described herein. The carrier vest may be adapted to fit a human torso and may include a pouch adapted to receive and store the one or more flexible ballistic resistant panels 100. Each flexible ballistic resistant panel 100 can include a portion of hook and loop fastener (or other suitable fastener) attached to an exterior surface of the panel. The fastener can permit a user to quickly add or remove panels 100 as needed to protect against ballistic threats. In one example, a soldier can modify the number of panels 100 in a stack of panels disposed in the pouch of the carrier vest 30 based on a threat level of a combat situation. If the threat level is higher than expected, the soldier can add one or more additional panels 100 to the stack for added protection. Alternately, if the threat level is lower than expected, the soldier can remove one or more panels from the stack of panels to reduce the weight of the stack, increase the flexibility of the stack, and thereby enhance the soldier's mobility.

In some examples, a modular armor system can include a carrier vest 30 adapted to fit a human torso, where the carrier vest includes a pouch adapted to receive and store one or more flexible ballistic resistant panels 100 as described herein. The one or more flexible ballistic resistant panels 100 can be adapted to fit inside the pouch of the carrier vest. Each of the flexible ballistic resistant panels 100 can include at least a first plurality of ballistic sheets 1020 and a second plurality of ballistic sheets 1025. The first plurality of ballistic sheets 1020 can be made of aramid fibers and a can be coated with a first resin having a first melting temperature. Similarly, the second plurality of ballistic sheets 1025, which can be adjacent to the first plurality of ballistic sheets 1020, can be made of aramid fibers and can be coated with a second resin having a second melting temperature, where the second melting temperature is greater than the first melting temperature.

Each of the one or more flexible ballistic resistant panels 100 can include a portion of hook and loop fastener attached to an exterior surface of the panel. The portion of hook and loop fastener can allow the flexible ballistic resistant panel 100 to be removably attached to a second flexible ballistic resistant panel 100 to prevent relative shifting. The first resin can be a thermoplastic polymer having a melting temperature of about 215-240 degrees F. The second resin can be a thermoplastic polymer having a melting temperature of about 255-295 or 295-330 degrees F. In some examples, the first resin can be polyethylene, and the second resin can be polypropylene. Within each flexible ballistic resistant panel 100, the first plurality of ballistic sheets 1020 can include 1-10, 10-20, or 20-30 ballistic sheets, such as K-FLEX 0/90 x-ply ballistic sheets, and the second plurality of ballistic sheets 1025 can include 1-10, 10-20, or 20-30 ballistic sheets, such as THERMOBALLISTIC 0/90 x-ply ballistic sheets.

### Protective Cover for Oil or Gas Pipeline

A flexible ballistic resistant panel 100 can be adapted to serve as a ballistic resistant cover for an oil or gas pipeline. The flexible ballistic resistant panel 100 can include a plurality of ballistic sheets 1005, and each of the plurality of ballistic sheets can be formed of an arrangement of high performance fibers. The arrangement of high performance fibers can define a two-dimensional pattern. The plurality of ballistic sheets 1005 can be stacked according to the two-dimensional pattern. Within the stack 1005, each of the plurality of ballistic sheets can be at least partially bonded to at least one adjacent ballistic sheet in the plurality of ballistic sheets. The flexible ballistic resistant panel 100 can also include a waterproof cover 1105 encasing the plurality of ballistic sheets. In some examples, the waterproof cover 1105 can include an adhesive coating on an inner surface. The adhesive coating can adhere the waterproof cover 1105 to an outer surface of the plurality of ballistic sheets to prevent movement of the waterproof cover relative to the plurality of ballistic sheets. The adhesive coating can be made of polyurethane, polyvinylchloride, polyethylene, or polypropylene. The waterproof cover 1105 can be made of rubber, NYLON, RAYON, ripstop NYLON, CORDURA, polyvinyl chloride, polyurethane, silicone elastomer, or fluoropolymer. The waterproof cover 1105 can be coated with an ultraviolet (UV) protectant to limit damage from sunlight exposure.

In some examples, the flexible ballistic resistant panel 100 can include a magnetic attachment feature configured to allow quick and easy mounting of the flexible ballistic resistant panel to an outer surface of a steel pipeline. In other examples, the magnetic attachment feature can be replaced with any other suitable attachment feature such as, for example, zippers, snaps, or hook and loop fasteners.

The plurality of ballistic sheets 1005 within flexible ballistic resistant panel 100 for the oil or gas pipeline can include about 1-10, 10-20, or 20-30 ballistic sheets. The plurality of ballistic sheets 1005 can be made from a plurality of aramid fibers coated with a thermoplastic polymer resin. The thermoplastic polymer resin can have a melting temperature of about 215-240, 255-295, or 295-330 degrees F. The panel 100 can be manufactured according to any of the manufacturing methods specifically described herein.

### Ballistic Performance Standards

The ballistic resistant panels 100 described herein can be configured to comply with certain performance standards, such as those set forth in NIJ Standard-0101.06, Ballistic Resistance of Body Armor (July 2008), which is hereby incorporated by reference in its entirety. The National Institute of Justice (NIJ), which is part of the U.S. Department of Justice (DOJ), is responsible for setting minimum performance standards for law enforcement equipment, including minimum performance standards for police body armor. Under NIJ Standard-0101.06, personal body armor is classified into five categories (IIA, II, IIIA, III, IV) based on ballistic performance of the armor. Type HA armor that is new and unworn is tested with 9 mm Full Metal Jacketed Round Nose (FMJ RN) bullets with a specified mass of 8.0 g (124 gr) and a velocity of 373 m/s±9.1 m/s (1225 ft/s±30 ft/s) and with 0.40 S&W Full Metal Jacketed (FMJ) bullets with a specified mass of 11.7 g (180 gr) and a velocity of 352 m/s±9.1 m/s (1155 ft/s±30 ft/s). Type II armor that is new and unworn is tested with 9 mm FMJ RN bullets with a specified mass of 8.0 g (124 gr) and a velocity of 398 m/s±9.1 m/s (1305 ft/s±30 ft/s) and with 0.357 Magnum Jacketed Soft Point (JSP) bullets with a specified mass of 10.2 g (158 gr) and a velocity of 436 m/s±9.1 m/s (1430 ft/s±30 ft/s). Type IIIA armor that is new and unworn shall be tested with 0.357 SIG FMJ Flat Nose (FN) bullets with a specified mass of 8.1 g (125 gr) and a velocity of 448 m/s±9.1 m/s (1470 ft/s±30 ft/s) and with 0.44 Magnum Semi Jacketed Hollow Point (SJHP) bullets with a specified mass of 15.6 g (240 gr) and a velocity of 436 m/s±9.1 m/s (1430 ft/s±30 ft/s). Type III flexible armor shall be tested in both the “as new” state and the conditioned state with 7.62 mm FMJ, steel jacketed bullets (U.S. Military designation M80) with a specified mass of 9.6 g (147 gr) and a velocity of 847 m/s±9.1 m/s (2780 ft/s±30 ft/s). Type IV flexible armor shall be tested in both the “as new” state and the conditioned state with 0.30 caliber AP bullets (U.S. Military designation M2 AP) with a specified mass of 10.8 g (166 gr) and a velocity of 878 m/s±9.1 m/s (2880 ft/s±30 ft/s).

The term “ballistic limit” describes the impact velocity required to perforate a target with a certain type of projectile. To determine the ballistic limit of a target, a series of experimental tests must be conducted. During the tests, the velocity of the certain type of projectile is increased until the target is perforated. The term “V₅₀” designates the velocity at which half of the certain type of projectiles fired at the target will penetrate the target and half will not.

### Panel Dimensions and Weight

The flexible ballistic resistant panels 100 described herein are lighter and thinner than existing panels with a similar threat level certification. For instance, an existing stitched panel certified as Type IIIA has a weight of about 1.25 pounds for a 1 foot by 1 foot panel and a thickness of about 0.300 inches. Conversely, the panels 100 described herein, which have achieved the same certification, have a weight of about 1.0 pound for a 1 foot by 1 foot panel and a thickness of about 0.215 inches. A panel that is thinner and lighter is more versatile and is suitable for a wider range of applications.

The foregoing description has been presented for purposes of illustration and description. It is not intended to be exhaustive or to limit the claims to the embodiments disclosed. Other modifications and variations may be possible in view of the above teachings. The embodiments were chosen and described to explain the principles of the invention and its practical application to enable others skilled in the art to best utilize the invention in various embodiments and various modifications as are suited to the particular use contemplated. It is intended that the claims be construed to include other alternative embodiments of the invention except insofar as limited by the prior art.

1-20. (canceled)

21. A ballistic resistant panel comprising:
a plurality of first sheets bonded to each other; and
a plurality of second sheets moveable in relation to each other.

22. The ballistic resistant panel of claim 21, wherein bonding resists movement of said plurality of first sheets relative to each other.

23. The ballistic resistant panel of claim 22:
wherein said plurality of first sheets comprises a first fiber and a first resin having a first melting point;
wherein said plurality of second sheets comprises a second fiber and a second resin having a second melting point; and
wherein said second melting point is higher than said first melting point.

24. The ballistic resistant panel of claim 23, wherein upon exposure of said ballistic resistant panel to a temperature between said first and second melting points, said plurality of first sheets bond to each other.

25. The ballistic resistant panel of claim 24, wherein upon exposure of said ballistic resistant panel to said temperature, said first resin softens, and upon a subsequent reduction in said temperature, said first resin effectively bonds said plurality of first sheets to each other.

26. The ballistic resistant panel of claim 24, wherein upon exposure of said ballistic resistant panel to said temperature, said plurality of second sheets do not bond to each other, permitting said plurality of second sheets to move in relation to each other.

27. The ballistic resistant panel of claim 21, wherein said plurality of first sheets are partially bonded to each other.

28. The ballistic resistant panel of claim 21, wherein said plurality of first sheets are fully bonded to each other.

29. The ballistic resistant panel of claim 23, wherein said first and second fibers are substantially similar.

30. The ballistic resistant panel of claim 23, wherein said first and second fibers are dissimilar.

31. The ballistic resistant panel of claim 23, wherein said first and second fibers comprise material selected from the group consisting of: polymer, metal, fiberglass, composite material, and combinations thereof.

32. The ballistic resistant panel of claim 23, wherein a construction of said first and second fibers is selected from the group consisting of: woven and non-woven.

33. The ballistic resistant panel of claim 23, wherein said first fiber, said second fiber, or both said first and second fibers are pre-impregnated with corresponding said first or second resin.

34. The ballistic resistant panel of claim 24, wherein upon an application of pressure, said plurality of first sheets bond to each other.

35. The ballistic resistant panel of claim 23, further comprising:
a plurality of third sheets comprising a third fiber and a third resin having a third melting point;
wherein said third melting point differs from at least one of said first and second melting points.

36. The ballistic resistant panel of claim 35:
wherein said plurality of second sheets disposes between said plurality of first sheets and said plurality of third sheets; and
wherein said first and third melting points are substantially similar.

37. The ballistic resistant panel of claim 36, wherein said ballistic resistant panel is substantially symmetrical from a front surface to a back surface, permitting said ballistic resistant panel to have a reversible configuration wherein either said front surface or said back surface can serve as a strike face.

38. The ballistic resistant panel of claim 35:
wherein said plurality of second sheets disposes between said plurality of first sheets and said plurality of third sheets; and
wherein said second and third melting points are substantially similar.

39. The ballistic resistant panel of claim 38, wherein said ballistic resistant panel is non-symmetrical from a front surface to a back surface.

40. The ballistic resistant panel of claim 21, further comprising a protective cover in which said plurality of first sheets and said plurality of second sheets are encased.
